(19) United States
(12) Patent Application Publication
(10) Pub. No.: US 2026/0222033 A1
(43) Pub. Date: Jul. 30, 2026

(54) METHOD FOR COLLECTING DATA AND COMMUNICATION APPARATUS

(71) Applicant: BEIJING XIAOMI MOBILE SOFTWARE CO., LTD., Beijing (CN)

(72) Inventor: Xueyuan GAO, Beijing (CN)

(73) Assignee: BEIJING XIAOMI MOBILE SOFTWARE CO., LTD., Beijing (CN)

(21) Appl. No.: 19/147,546

(22) PCT Filed: Jan. 13, 2023
(86) PCT No.: PCT/CN2023/072184

§ 371 Date: Jul. 11, 2025

(51) Int. Cl. H04B 7/06

(52) U.S. Cl. CPC H04B 7/0626

(57) ABSTRACT

A method for collecting data and an apparatus are provided. The method for collecting data performed by a network-side device includes: the network-side device receiving first data information sent by a terminal to perform a model processing of a CSI generation model and/or a CSI recovery model or calculate CSI based on the first data information.

### CROSS-REFERENCE TO RELATED APPLICATIONS

The present application is a U.S. National Phase of International Application No. PCT/CN2023/072184, filed on Jan. 13, 2023, the entire content of which is incorporated herein by reference for all purposes.

### FIELD

The present disclosure relates to the field of communication technologies, and particularly to a method for collecting data and an apparatus.

### BACKGROUND

In the related art, a bilateral model based on a channel state information (CSI) generation part model of a terminal and a CSI recovery part model of a network-side device is proposed, which respectively implement CSI compression feedback and recovery.

The CSI generation part model and/or the CSI recovery part model may be trained at the network-side device or used for calculating CSI. How the network-side device obtains the data information for training the CSI generation part model and/or the CSI recovery part model or calculating CSI is an urgent problem to be solved.

### SUMMARY

In a first aspect, an embodiment of the present disclosure provides a method for collecting data, performed by a network-side device, including: the network-side device receiving first data information sent by a terminal to perform a model processing of a CSI generation model and/or a CSI recovery model or calculate CSI based on the first data information.

In a second aspect, an embodiment of the present disclosure provides another method for collecting data, performed by a terminal, including: sending first data information to a network-side device, where the first data information is used for the network-side device to perform a model processing of a CSI generation model and/or a CSI recovery model or calculate CSI.

In a third aspect, an embodiment of the present disclosure provides a communication apparatus, where the communication apparatus has some or all functions of the network-side device in the method described in the first aspect. For example, the functions of the communication apparatus may include some or all functions in the embodiments of the present disclosure or may include the function of any single embodiment of the present disclosure. The functions may be implemented by hardware or by hardware executing corresponding software. The hardware or software includes one or more units or modules corresponding to the above functions.

In one implementation, the structure of the communication apparatus may include a transceiver module and a processing module, where the processing module is configured to support the communication apparatus in performing corresponding functions in the above method. The transceiver module is used to support communication between the communication apparatus and other devices. The communication apparatus may further include a storage module, where the storage module is coupled to the transceiver module and the processing module and stores necessary computer programs and data for the communication apparatus.

In one implementation, the communication apparatus includes: a transceiver module, configured to receive first data information sent by a terminal to perform a model processing of a CSI generation model and/or a CSI recovery model or calculate CSI based on the first data information.

In a fourth aspect, an embodiment of the present disclosure provides another communication apparatus, where the communication apparatus has some or all functions of the terminal in the method described in the second aspect. For example, the functions of the communication apparatus may include some or all functions in the embodiments of the present disclosure or may include the function of any single embodiment of the present disclosure. The functions may be implemented by hardware or by hardware executing corresponding software. The hardware or software includes one or more units or modules corresponding to the above functions.

In one implementation, the structure of the communication apparatus may include a transceiver module and a processing module, where the processing module is configured to support the communication apparatus in performing corresponding functions in the above method. The transceiver module is used to support communication between the communication apparatus and other devices. The communication apparatus may further include a storage module, where the storage module is coupled to the transceiver module and the processing module and stores necessary computer programs and data for the communication apparatus.

In one implementation, the communication apparatus includes: a transceiver module, configured to send first data information to a network-side device, where the first data information is used for the network-side device to perform a model processing of a CSI generation model and/or a CSI recovery model or calculate CSI.

In a fifth aspect, an embodiment of the present disclosure provides a communication apparatus, including a processor, where the processor is configured to invoke a computer program in a memory to perform the method described in the first aspect.

In a sixth aspect, an embodiment of the present disclosure provides a communication apparatus, including a processor, where the processor is configured to invoke a computer program in a memory to perform the method described in the second aspect.

In a seventh aspect, an embodiment of the present disclosure provides a communication apparatus, including a processor and a memory, where the memory stores a computer program; the processor executes the computer program stored in the memory to cause the communication apparatus to perform the method described in the first aspect.

In an eighth aspect, an embodiment of the present disclosure provides a communication apparatus, including a processor and a memory, where the memory stores a computer program; the processor executes the computer program stored in the memory to cause the communication apparatus to perform the method described in the second aspect.

In a ninth aspect, an embodiment of the present disclosure provides a communication apparatus, including a processor and an interface circuit, where the interface circuit is configured to receive code instructions and transmit the code instructions to the processor, and the processor is configured to run the code instructions to cause the apparatus to perform the method described in the first aspect.

In a tenth aspect, an embodiment of the present disclosure provides a communication apparatus, including a processor and an interface circuit, where the interface circuit is configured to receive code instructions and transmit the code instructions to the processor, and the processor is configured to run the code instructions to cause the apparatus to perform the method described in the second aspect.

In an eleventh aspect, an embodiment of the present disclosure provides a data collection system, including the communication apparatus described in the third aspect and the communication apparatus described in the fourth aspect, or including the communication apparatus described in the fifth aspect and the communication apparatus described in the sixth aspect, or including the communication apparatus described in the seventh aspect and the communication apparatus described in the eighth aspect, or including the communication apparatus described in the ninth aspect and the communication apparatus described in the tenth aspect.

In a twelfth aspect, an embodiment of the present disclosure provides a computer-readable storage medium, storing instructions that, when executed by a processor, cause the processor to implement the method described in the first aspect.

In a thirteenth aspect, an embodiment of the present disclosure provides a computer-readable storage medium, storing instructions that, when executed by a processor, cause the processor to implement the method described in the second aspect.

In a fourteenth aspect, the present disclosure further provides a computer program product including a computer program, where the computer program, when executed on a computer, causes the computer to perform the method described in the first aspect.

In a fifteenth aspect, the present disclosure further provides a computer program product including a computer program, where the computer program, when executed on a computer, causes the computer to perform the method described in the second aspect.

In a sixteenth aspect, the present disclosure provides a chip system, including at least one processor and an interface, configured to support a network-side device in implementing functions related to the first aspect, for example, determining or processing at least one of data and information involved in the above method. In one possible design, the chip system further includes a memory, where the memory is configured to store necessary computer programs and data for the network-side device. The chip system may be composed of chips or may include chips and other discrete devices.

In a seventeenth aspect, the present disclosure provides a chip system, including at least one processor and an interface, configured to support a terminal in implementing functions related to the second aspect, for example, determining or processing at least one of data and information involved in the above method. In one possible design, the chip system further includes a memory, where the memory is configured to store necessary computer programs and data for the terminal. The chip system may be composed of chips or may include chips and other discrete devices.

In an eighteenth aspect, the present disclosure provides a computer program, where the computer program, when executed on a computer, causes the computer to perform the method described in the first aspect.

In a nineteenth aspect, the present disclosure provides a computer program, where the computer program, when executed on a computer, causes the computer to perform the method described in the second aspect.

### BRIEF DESCRIPTION OF THE DRAWINGS

To describe the technical solutions in the embodiments of the present disclosure or the background more clearly, the following briefly introduces the accompanying drawings required for describing the embodiments or the background.

FIG. 1 is an architecture diagram of a communication system in an embodiment of the present disclosure;

FIG. 2 is a schematic diagram of implementing CSI compression feedback and recovery based on a bilateral AI/ML model in an embodiment of the present disclosure;

FIG. 3 is a flowchart of a method for collecting data in an embodiment of the present disclosure;

FIG. 4 is a flowchart of another method for collecting data in an embodiment of the present disclosure;

FIG. 5 is a flowchart of yet another method for collecting data in an embodiment of the present disclosure;

FIG. 6 is a flowchart of yet another method for collecting data in an embodiment of the present disclosure;

FIG. 7 is a flowchart of yet another method for collecting data in an embodiment of the present disclosure;

FIG. 8 is a flowchart of yet another method for collecting data in an embodiment of the present disclosure;

FIG. 9 is a flowchart of yet another method for collecting data in an embodiment of the present disclosure;

FIG. 10 is a flowchart of yet another method for collecting data in an embodiment of the present disclosure;

FIG. 11 is a flowchart of yet another method for collecting data in an embodiment of the present disclosure;

FIG. 12 is a flowchart of yet another method for collecting data in an embodiment of the present disclosure;

FIG. 13 is a flowchart of yet another method for collecting data in an embodiment of the present disclosure;

FIG. 14 is a flowchart of yet another method for collecting data in an embodiment of the present disclosure;

FIG. 15 is a flowchart of yet another method for collecting data in an embodiment of the present disclosure;

FIG. 16 is a flowchart of yet another method for collecting data in an embodiment of the present disclosure;

FIG. 17 is a flowchart of yet another method for collecting data in an embodiment of the present disclosure;

FIG. 18 is a structural diagram of a communication apparatus in an embodiment of the present disclosure;

FIG. 19 is a structural diagram of another communication apparatus in an embodiment of the present disclosure; and

FIG. 20 is a schematic structural diagram of a chip in an embodiment of the present disclosure.

### DETAILED DESCRIPTION

To better understand the method for collecting data and apparatus provided by the embodiments of the present disclosure, the communication system applicable to the embodiments of the present disclosure is first described below.

The embodiments of the present disclosure are described in detail below with reference to the accompanying drawings. The examples of the embodiments are illustrated in the accompanying drawings, where the same or similar reference numerals indicate the same or similar elements or elements with the same or similar functions. The embodiments described below with reference to the accompanying drawings are exemplary and are intended to explain the present disclosure but should not be construed as limiting the present disclosure. In the description of the present disclosure, unless otherwise specified, “/” means “or,” for example, A/B may represent A or B; the term “and/or” herein is only used to describe an association relationship of associated objects, indicating that there may be three relationships, for example, A and/or B may represent: A alone, both A and B, or B alone.

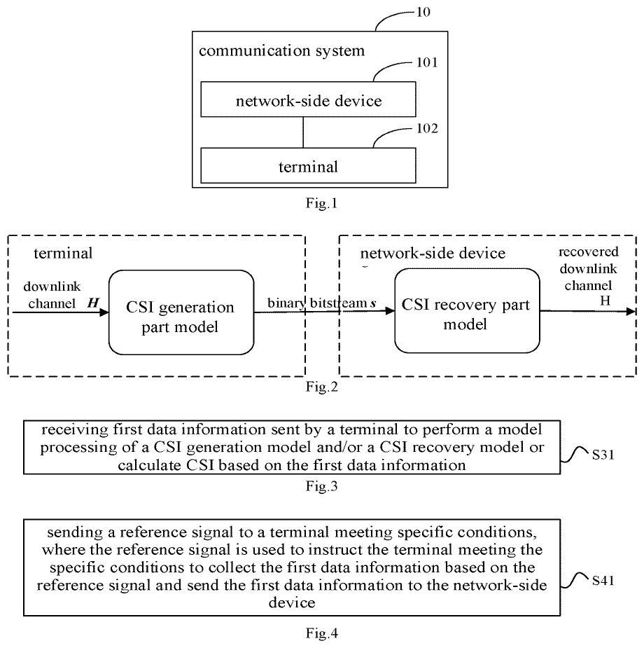

Please refer to FIG. 1, which is a schematic diagram of a communication system architecture in an embodiment of the present disclosure. The communication system may include, but is not limited to, one network-side device and one terminal. The number and form of devices shown in FIG. 1 are only for illustration and do not limit the embodiments of the present disclosure. In practical applications, the system may include two or more network-side devices and two or more terminals. The communication system 10 shown in FIG. 1 includes one network-side device 101 and one terminal 102 as an example.

It should be noted that the technical solutions of the embodiments of the present disclosure may be applied to various communication systems, such as a Long-Term Evolution (LTE) system, a fifth-generation (5G) mobile communication system, a 5G New Radio (NR) system, or other future new mobile communication systems.

The network-side device 101 in the embodiments of the present disclosure is an entity on the network side for transmitting or receiving signals. For example, the network-side device 101 may be an evolved NodeB (eNB), a transmission reception point (TRP), a next-generation NodeB (gNB) in an NR system, a base station in other future mobile communication systems, or an access node in a wireless fidelity (WiFi) system. The embodiments of the present disclosure do not limit the specific technology and device form adopted by the network-side device 101. The network-side device 101 provided by the embodiments of the present disclosure may be composed of a central unit (CU) and a distributed unit (DU), where the CU may also be referred to as a control unit. The CU-DU structure may split the protocol layers of the network-side device 101, for example, the functions of some protocol layers are centrally controlled by the CU, and the remaining functions of some or all protocol layers are distributed in the DU and centrally controlled by the CU.

The terminal 102 in the embodiments of the present disclosure is an entity on the user side for receiving or transmitting signals, such as a mobile phone. The terminal may also be referred to as user equipment (UE), a terminal, a mobile station (MS), a mobile terminal (MT), etc. The terminal may be a car with communication functions, a smart car, a mobile phone, a wearable device, a tablet (Pad), a computer with wireless transceiver functions, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, etc. The embodiments of the present disclosure do not limit the specific technology and device form adopted by the terminal.

It should be understood that the communication system described in the embodiments of the present disclosure is to more clearly illustrate the technical solutions of the embodiments of the present disclosure and does not limit the scope of the technical solutions provided by the embodiments of the present disclosure. Those skilled in the art will understand that as the system architecture evolves and new service scenarios emerge, the technical solutions provided by the embodiments of the present disclosure are equally applicable to similar technical problems.

In addition, to facilitate the understanding of the embodiments of the present disclosure, the following points are explained.

First, in the embodiments of the present disclosure, “used to indicate” may include direct indication and indirect indication. When describing that certain information is used to indicate A, it may include that the information carries A, or may also include that the information directly or indirectly indicates A, but does not necessarily mean that the information must carry A.

The information indicated by the information is referred to as the to-be-indicated information. In specific implementations, there are many ways to indicate the to-be-indicated information, including but not limited to directly indicating the to-be-indicated information, such as the to-be-indicated information itself or an index of the to-be-indicated information. The to-be-indicated information may also be indirectly indicated by indicating other information, where there is an association relationship between the other information and the to-be-indicated information. It is also possible to indicate only part of the to-be-indicated information, while the other part of the to-be-indicated information is known or agreed upon in advance. For example, the indication of specific information may also be implemented by relying on a predefined (e.g., protocol-defined) arrangement order of various pieces of information, thereby reducing the indication overhead to some extent.

The to-be-indicated information may be sent as a whole or may be divided into multiple sub-information for separate transmission, and the transmission periods and/or timings of these sub-information may be the same or different. The specific transmission method is not limited in the present disclosure. The transmission periods and/or timings of these sub-information may be predefined, for example, predefined according to a protocol.

Second, in the present disclosure, terms such as “first,” “second,” and various numerical labels (e.g., “#1,” “#2”) are only used for distinguishing descriptions and do not limit the scope of the embodiments of the present disclosure. For example, they are used to distinguish different information.

Third, the embodiments of the present disclosure list multiple implementations to clearly illustrate the technical solutions of the embodiments of the present disclosure. Of course, those skilled in the art will understand that the multiple embodiments provided by the embodiments of the present disclosure may be executed alone or in combination with other embodiments of the present disclosure, or may be executed in combination with some methods in other related technologies. The embodiments of the present disclosure do not limit this.

Research in academia or industry shows that artificial intelligence (AI) technology can also be applied to the field of wireless communications. Compared with traditional technical means, AI technology can also achieve good results. In related technologies, the use of AI technology can reduce the feedback overhead of terminals or improve the accuracy of channel state information (CSI) feedback, and 3GPP standardization research has been conducted on a bilateral AI/machine learning (ML) model based on a CSI generation part model of terminals and a CST recovery part model of network-side devices to implement CSI compression feedback and recovery, respectively. As shown in FIG. 2, a schematic diagram of implementing CSI compression feedback and recovery based on a bilateral AI/ML model is provided. The terminal compresses downlink channel information H through the CSI generation part model, quantizes it into a binary bit stream, and sends it to the network-side device. The network-side device recovers an approximation H′ of the original downlink information through the CSI recovery part model.

The CSI generation part model and the CSI recovery part model need to be trained using collected datasets. The types of training for the CSI generation part model and the CSI recovery part model include the following three types:

Training Type 1: the model is trained on a single side (e.g., at the terminal or the network-side device), and then the trained part model is sent to the other side.

For example, Training Type 1 can be divided into:

Training at the terminal: the CSI generation part model and the CSI recovery part model are trained at the terminal, and after the training is completed, the obtained CSI recovery part model is sent to the network-side device.

Training at the network-side device: the CSI generation part model and the CSI recovery part model are trained at the network-side device, and after the training is completed, the obtained CSI generation part model is sent to the terminal.

Training Type 2: the CSI generation part model and the CSI recovery part model are trained jointly at the terminal and the network-side device, respectively.

Training Type 3: the model is first trained on one side, and then the trained data or other auxiliary information is sent to the other side to complete the training of the other part model.

For example, Training Type 3 can be further divided into:

NW-first training at the network-side device: the network-side device first trains the CSI generation part model and the CSI recovery part model, and then sends the dataset and/or other auxiliary information for training the CSI generation part model to the terminal.

UE-first training at the terminal: the terminal first trains the CSI generation part model and the CSI recovery part model, and then sends the dataset and/or other auxiliary information for training the CSI recovery part model to the network-side device.

The auxiliary information in Training Type 3 may include quantization information output by the CSI generation part model, structural information of the AI/MIL model, etc. The data collection for training the AT/ML model can be implemented by the terminal or the network-side device. For different training types, how to implement data collection by the terminal and the network-side device through signaling design, process design, and/or transmission method design for online or offline training, inference, model monitoring, model fine-tuning, and data analysis of the bilateral AI/ML model is a problem to be solved.

In the embodiments of the present disclosure, the CSI generation part model and/or the CSI recovery part model may be trained or used for calculating CSI at the network-side device. How the network-side device obtains the data information for training or calculating CSI using the CSI generation part model and/or the CSI recovery part model is an urgent problem to be solved.

Based on this, the embodiments of the present disclosure provide a method for collecting data, where the network-side device receives first data information sent by the terminal to perform a model processing of the CSI generation model and/or the CSI recovery model or calculate CSI based on the first data information. Thus, the network-side device can obtain the first data information for performing model processing of the CSI generation model and/or the CSI recovery model or calculating CSI, thereby enabling online or offline training, inference, model monitoring, model fine-tuning, and data analysis of the CSI generation model and/or the CSI recovery model.

The method for collecting data and apparatus provided by the present disclosure are described in detail below with reference to the accompanying drawings.

Please refer to FIG. 3, which is a flowchart of a method for collecting data in an embodiment of the present disclosure. As shown in FIG. 3, the method is performed by a network-side device and may include, but is not limited to, the following steps:

S31: receiving first data information sent by a terminal to perform a model processing of a CSI generation model and/or a CSI recovery model or calculate CSI based on the first data information.

In the embodiments of the present disclosure, the network-side device may receive the first data information sent by the terminal. The network-side device may receive the first data information actively reported by the terminal or may send a specific indication to the terminal to instruct the terminal to report the first data information.

In some embodiments, the network-side device receives the first data information sent by the terminal through uplink data transmission or uplink control information (UCI).

It should be understood that when the network-side device sends a specific indication to instruct the terminal to report the first data information, the network-side device may determine that model processing of the CSI generation model and/or the CST recovery model or calculation of CSI needs to be performed at the network-side device, and based on this, send the specific indication to the terminal.

In some embodiments, the network-side device sends second indication information to the terminal, where the second indication information is used to indicate that the network-side device needs to perform a model processing of the CSI generation model and/or the CSI recovery model or calculate CSI.

In the embodiments of the present disclosure, the network-side device sends the second indication information to the terminal, where the second indication information is used to indicate that the network-side device needs to perform a model processing of the CSI generation model and/or the CSI recovery model or calculate CSI. Based on this, the terminal may determine that the network-side device needs to perform a model processing of the CSI generation model and/or the CSI recovery model or calculate CSI. In this case, the terminal may send the first data information to the network-side device according to the second indication information.

The network-side device may send the second indication information to the terminal by sending at least one of radio resource control (RRC) signaling, a medium access control (MAC) control element (CE), or downlink control information (DCI) signaling, where at least one of the RRC signaling, MAC-CE, or DCI signaling includes the second indication information.

In an embodiment, the network-side device sends the second indication information to the terminal, where the second indication information is used to indicate that the network-side device needs to perform a model processing of the CSI generation model and the CSI recovery model or calculate CSI.

In one possible implementation, the second indication information may indicate using the Training Type 1 for training the model, where the CSI generation model and the CST recovery model are trained at the network-side device. Based on this, after receiving the second indication information sent by the network-side device, the terminal may send the first data information to the network-side device, so that the network-side device can perform a model processing of the CSI generation model and the CSI recovery model or calculate CSI based on the first data information.

In another possible implementation, the second indication information may indicate using Training Type 3 for training the model, where the CSI generation model and the CSI recovery model are first trained at the network-side device, and then the network-side device sends the dataset and/or other auxiliary information for training the CSI generation model to the terminal, and the CSI generation model is trained at the terminal. Based on this, after receiving the second indication information sent by the network-side device, the terminal may send the first data information to the network-side device, so that the network-side device can perform a model processing of the CSI generation model and the CSI recovery model or calculate CSI based on the first data information.

In another embodiment, the network-side device sends the second indication information to the terminal, where the second indication information is used to indicate that the network-side device needs to perform a model processing on the CSI recovery model or calculate CSI.

In one possible implementation, the second indication information may indicate Training Type 3, where the CSI generation model and the CSI recovery model are first trained at the terminal, and then the terminal sends the dataset and/or other auxiliary information for training the CSI recovery model to the network-side device. The second indication information may be used to instruct the terminal to send the dataset and/or other auxiliary information for training the CSI recovery model to the network-side device. Based on this, after receiving the second indication information sent by the network-side device, the terminal may send the first data information to the network-side device, so that the network-side device can perform a model processing on the CSI recovery model or calculate CSI based on the first data information.

In another possible implementation, the second indication information may indicate using Training Type 2 for training the model, where the CSI generation model and the CSI recovery model are jointly trained at the terminal and the network-side device, respectively. The CSI generation model is jointly trained at the terminal and the CSI recovery model is jointly trained at the network-side device. Based on this, after receiving the second indication information sent by the network-side device, the terminal may send the first data information to the network-side device, so that the network-side device can perform a model processing on the CSI recovery model or calculate CSI based on the first data information.

It should be understood that when the network-side device receives the first data information actively reported by the terminal, the terminal may determine on its own that the network-side device needs to perform a model processing of the CSI generation model and/or the CSI recovery model or calculate CSI, and in this case, send the first data information to the network-side device.

It should also be understood that the network-side device may determine that model processing of the CSI generation model and/or the CSI recovery model or calculation of CSI needs to be performed at the network-side device based on protocol agreements, or may determine it on its own, or may determine it based on an indication from the terminal.

In some embodiments, the network-side device receives first indication information sent by the terminal, where the first indication information is used to instruct the network-side device to perform a model processing of the CSI generation model and/or the CSI recovery model or calculate CSI.

In the embodiments of the present disclosure, the network-side device receives the first indication information sent by the terminal, where the first indication information instructs the network-side device to perform a model processing of the CSI generation model and/or the CSI recovery model or calculate CSI. Thus, the network-side device may determine that model processing of the CSI generation model and/or the CSI recovery model or calculation of CSI needs to be performed at the network-side device.

In an embodiment, the network-side device receives the first indication information sent by the terminal, where the first indication information is used to instruct the network-side device to perform a model processing of the CSI generation model and the CSI recovery model or calculate CSI.

In one possible implementation, the first indication information may indicate Training Type 1, where the CSI generation model and the CSI recovery model are trained at the network-side device. Based on this, after receiving the first indication information sent by the terminal, the network-side device may determine to use Training Type 1 and train the CSI generation model and the CSI recovery model at the network-side device.

In another possible implementation, the first indication information may indicate using Training Type 3 for training the model, where the CSI generation model and the CSI recovery model are first trained at the network-side device, and then the network-side device sends the dataset and/or other auxiliary information for training the CSI generation model to the terminal, and the CSI generation model is trained at the terminal. Based on this, after receiving the first indication information sent by the terminal, the network-side device may determine to use Training Type 3, train the CSI generation model and the CSI recovery model at the network-side device, and then send the dataset and/or other auxiliary information for training the CSI generation model to the terminal, so that the CSI generation model can be trained at the terminal.

In another embodiment, the network-side device receives the first indication information sent by the terminal, where the first indication information is used to instruct the network-side device to perform a model processing on the CSI recovery model or calculate CSI.

In one possible implementation, the first indication information may indicate Training Type 3, where the CSI generation model and the CSI recovery model are first trained at the terminal, and then the terminal sends the dataset and/or other auxiliary information for training the CSI recovery model to the network-side device. Based on this, after receiving the first indication information sent by the terminal, the network-side device may determine to perform a model processing on the CSI recovery model or calculate CSI at the network-side device.

In another possible implementation, the first indication information may indicate Training Type 2, where the CSI generation model and the CSI recovery model are jointly trained at the terminal and the network-side device, respectively, with the CSI generation model trained at the terminal and the CSI recovery model trained at the network-side device. Based on this, after receiving the first indication information sent by the terminal, the network-side device may determine to perform a model processing on the CSI recovery model or calculate CSI at the network-side device.

In some embodiments, the first data information includes at least one of the following:
forward propagation (FP) data;
estimated downlink channel information;
a feature vector corresponding to downlink channel information;
input data during training of the CSI recovery model at the terminal;
output data during training of the CSI recovery model at the terminal;
codebook parameter information;
compressed estimated downlink channel information;
a compressed feature vector corresponding to downlink channel information;
compressed input data during training of the CSI recovery model at the terminal;
compressed output data during training of the CSI recovery model at the terminal; or
compressed codebook vector information.

In the embodiments of the present disclosure, the first data information includes FP data.

In the embodiments of the present disclosure, the first data information includes estimated downlink channel information.

In the embodiments of the present disclosure, the first data information includes a feature vector corresponding to downlink channel information.

In the embodiments of the present disclosure, the first data information includes input data during training of the CSI recovery model at the terminal.

In the embodiments of the present disclosure, the first data information includes output data during training of the CSI recovery model at the terminal.

In the embodiments of the present disclosure, the first data information includes codebook parameter information.

In the embodiments of the present disclosure, the first data information includes compressed estimated downlink channel information.

In the embodiments of the present disclosure, the first data information includes a compressed feature vector corresponding to downlink channel information.

In the embodiments of the present disclosure, the first data information includes compressed input data during training of the CSI recovery model at the terminal.

In the embodiments of the present disclosure, the first data information includes compressed output data during training of the CSI recovery model at the terminal.

In the embodiments of the present disclosure, the first data information includes compressed codebook vector information.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In an embodiment, the network-side device receives the first data information sent by the terminal, where the first data information includes compressed estimated downlink channel information. The terminal is deployed with a reference CSI generation model and/or a reference CSI recovery model, which can compress the estimated downlink channel information of the terminal to obtain compressed estimated downlink channel information and send the compressed estimated downlink channel information to the network-side device.

In another embodiment, the network-side device receives the first data information sent by the terminal, where the first data information includes a compressed feature vector corresponding to downlink channel information. The terminal is deployed with a reference CSI generation model and/or a reference CSI recovery model, which can compress the feature vector corresponding to the downlink channel information to obtain a compressed feature vector corresponding to the downlink channel information and send the compressed feature vector to the network-side device.

In another embodiment, the network-side device receives the first data information sent by the terminal, where the first data information includes compressed input data during training of the CSI recovery model at the terminal. The terminal is deployed with a reference CST generation model and/or a reference CSI recovery model, which can compress the input data during training of the CSI recovery model at the terminal to obtain compressed input data and send the compressed input data to the network-side device.

In another embodiment, the network-side device receives the first data information sent by the terminal, where the first data information includes compressed output data during training of the CSI recovery model at the terminal. The terminal is deployed with a reference CSI generation model and/or a reference CSI recovery model, which can compress the output data during training of the CSI recovery model at the terminal to obtain compressed output data and send the compressed output data to the network-side device.

In another embodiment, the network-side device receives the first data information sent by the terminal, where the first data information includes compressed codebook vector information. The terminal is deployed with a reference CSI generation model and/or a reference CSI recovery model, which can compress the codebook vector information to obtain compressed codebook vector information and send the compressed codebook vector information to the network-side device.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In some embodiments, the network-side device sends event indication information to the terminal, where the event indication information is used to instruct the terminal to collect the first data information when a specific event is met and/or stop collecting the first data information when the specific event is not met.

In the embodiments of the present disclosure, the network-side device may send event indication information to the terminal, where the event indication information is used to instruct the terminal to collect the first data information when a specific event is met and/or stop collecting the first data information when the specific event is not met.

The network-side device may send the event indication information to the terminal by sending at least one of RRC signaling, MAC-CE, or DCI signaling, where the RRC signaling, MAC-CE, or DCI signaling includes the event indication information.

In some embodiments, when the network-side device trains the CSI recovery model based on the first data information, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

In the embodiments of the present disclosure, in Training Type 3, where the CSI generation model and the CSI recovery model are trained at the terminal and the CSI recovery model is trained at the network-side device, the first auxiliary information includes: preprocessing information output by the CSI recovery model or quantization method indication information output by the CSI generation model and reported by the terminal when the CSI generation model and the CSI recovery model are trained at the terminal.

In the embodiments of the present disclosure, the network-side device receives the first data information sent by the terminal to perform a model processing of the CSI generation model and/or the CSI recovery model based on the first data information, which can enable online or offline training, fine-tuning, and monitoring of the CSI generation model and/or the CSI recovery model at the network-side device.

In the embodiments of the present disclosure, the network-side device receives the first data information sent by the terminal to calculate CSI for the CSI generation model and/or the CSI recovery model based on the first data information, which can enable inference, monitoring, and data analysis of the CSI generation model and/or the CSI recovery model at the network-side device.

By implementing the embodiments of the present disclosure, the network-side device receives the first data information sent by the terminal to perform a model processing of the CSI generation model and/or the CSI recovery model or calculate CSI based on the first data information. Thus, the network-side device can obtain the first data information for performing model processing of the CSI generation model and/or the CSI recovery model or calculating CSI, thereby enabling online, or offline training, inference, model monitoring, fine-tuning, and data analysis of the CSI generation model and/or CSI recovery model.

Please refer to FIG. 4, which is a flowchart of another method for collecting data in an embodiment of the present disclosure. As shown in FIG. 4, the method is performed by a network-side device and may include, but is not limited to, the following steps:

S41: sending a reference signal to a terminal meeting specific conditions, where the reference signal is used to instruct the terminal meeting the specific conditions to collect the first data information based on the reference signal and send the first data information to the network-side device.

In the embodiments of the present disclosure, a cell-specific reference signal is designed, enabling terminals within a specific cell to complete the collection of the first data information based on the cell-specific reference signal sent by the network-side device and send the first data information to the network-side device.

In an embodiment, a terminal group-specific or area-specific reference signal may be designed, enabling terminals within a specific terminal group or area to complete the collection of the first data information based on the reference signal and then send the collected first data information to the network-side device.

In the embodiments of the present disclosure, the network-side device sends the reference signal to the terminal meeting the specific conditions, where the reference signal is used to instruct the terminal meeting the specific conditions to collect the first data information based on the reference signal and send it to the network-side device. Thus, after receiving the reference signal, the terminal meeting the specific conditions can collect the first data information and send it to the network-side device.

The network-side device may send the reference signal to the terminal meeting the specific conditions by sending at least one of RRC signaling, MAC-CE, or DCI signaling, where the RRC signaling, MAC-CE, or DCI signaling includes the reference signal.

In some embodiments, the specific conditions include at least one of the following:
the terminal belonging to a specific cell;
the terminal belonging to a specific terminal group;
the terminal belonging to a specific area.

In the embodiments of the present disclosure, the specific conditions include belonging to a specific cell, and the terminal meeting the specific conditions may be a terminal belonging to the specific cell.

In the embodiments of the present disclosure, the specific conditions include belonging to a specific terminal group, and the terminal meeting the specific conditions may be a terminal belonging to the specific terminal group.

In the embodiments of the present disclosure, the specific conditions include belonging to a specific area, and the terminal meeting the specific conditions may be a terminal belonging to the specific area.

In some embodiments, the network-side device sends the reference signal to the terminal meeting the specific conditions by broadcasting the reference signal to the terminal meeting the specific conditions.

In some embodiments, the first data information includes at least one of the following:
FP data;
estimated downlink channel information;
a feature vector corresponding to downlink channel information;
input data during training of the CSI recovery model at the terminal;
output data during training of the CSI recovery model at the terminal;
codebook parameter information;
compressed estimated downlink channel information;
a compressed feature vector corresponding to downlink channel information;
compressed input data during training of the CSI recovery model at the terminal;
compressed output data during training of the CSI recovery model at the terminal;
compressed codebook vector information.

In the embodiments of the present disclosure, the first data information includes FP data.

In the embodiments of the present disclosure, the first data information includes estimated downlink channel information.

In the embodiments of the present disclosure, the first data information includes a feature vector corresponding to downlink channel information.

In the embodiments of the present disclosure, the first data information includes input data during training of the CSI recovery model at the terminal.

In the embodiments of the present disclosure, the first data information includes output data during training of the CSI recovery model at the terminal.

In the embodiments of the present disclosure, the first data information includes codebook parameter information.

In the embodiments of the present disclosure, the first data information includes compressed estimated downlink channel information.

In the embodiments of the present disclosure, the first data information includes a compressed feature vector corresponding to downlink channel information.

In the embodiments of the present disclosure, the first data information includes compressed input data during training of the CSI recovery model at the terminal.

In the embodiments of the present disclosure, the first data information includes compressed output data during training of the CSI recovery model at the terminal.

In the embodiments of the present disclosure, the first data information includes compressed codebook vector information.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In an embodiment, the first data information includes estimated downlink channel information. After receiving the reference signal sent by the network-side device, the terminal may estimate the downlink channel to obtain the estimated downlink channel information and send the estimated downlink channel information to the network-side device.

The terminal may report the estimated downlink channel information to the network-side device through CSI.

In another embodiment, the first data information includes a feature vector corresponding to downlink channel information. After receiving the reference signal sent by the network-side device, the terminal may estimate the downlink channel to obtain the feature vector corresponding to the estimated downlink channel information and send the feature vector to the network-side device.

The terminal may report the feature vector corresponding to the downlink channel information to the network-side device through CSI.

In an embodiment, the first data information includes compressed estimated downlink channel information or a compressed feature vector corresponding to downlink channel information. After receiving the reference signal sent by the network-side device, the terminal may estimate the downlink channel to obtain the estimated downlink channel information or the feature vector corresponding to the downlink channel information. The terminal may compress the obtained estimated downlink channel information or feature vector corresponding to the downlink channel information to obtain the compressed estimated downlink channel information or compressed feature vector corresponding to the downlink channel information and then send it to the network-side device.

After receiving the compressed estimated downlink channel information or compressed feature vector corresponding to downlink channel information sent by the terminal, the network-side device may recover the pre-compression estimated downlink channel information or feature vector corresponding to the downlink channel information. Based on this, the network-side device may perform a model processing of the CSI generation model and/or the CSI recovery model or calculate CSI based on the estimated downlink channel information or feature vector corresponding to downlink channel information.

In another embodiment, a reference CSI generation part model is deployed at the terminal, and a reference CSI recovery part model is deployed at the network-side device. The reference CSI generation part model at the terminal is used to compress the estimated downlink channel information of the terminal or to compress the feature vector corresponding to the downlink channel information or Type II codebook vector and then send it to the network-side device. The reference CSI recovery part model at the network-side device may recover the compressed estimated downlink channel information sent by the terminal to obtain the estimated downlink channel information or recover the compressed feature vector corresponding to downlink channel information or Type II codebook vector sent by the terminal to obtain the feature vector corresponding to downlink channel information or Type II codebook vector.

It should be noted that the above examples are only illustrative and do not specifically limit the embodiments of the present disclosure. The content included in the first data information may also be other data information. The terminal may perform corresponding processing to obtain the first data information, and the network-side device may perform corresponding processing on the first data information to perform a model processing of the CSI generation model and/or the CSI recovery model or calculate CSI based on the first data information.

In some embodiments, the network-side device receives indication information sent by the terminal, where the indication information is used to indicate at least one of the following:
the geographical location of the terminal;
the area identifier of the terminal;
the time-domain channel characteristics reported by the terminal; or
the time-domain correlation of the terminal.

In the embodiments of the present disclosure, the network-side device receives the indication information sent by the terminal, where the indication information is used to indicate the geographical location of the terminal.

In the embodiments of the present disclosure, the network-side device receives the indication information sent by the terminal, where the indication information is used to indicate the area identifier of the terminal.

In the embodiments of the present disclosure, the network-side device receives the indication information sent by the terminal, where the indication information is used to indicate the time-domain channel characteristics reported by the terminal.

In the embodiments of the present disclosure, the network-side device receives the indication information sent by the terminal, where the indication information is used to indicate the time-domain correlation of the terminal.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In some embodiments, the network-side device determines a terminal group, or an area, or a moving speed of the terminal based on the indication information.

In the embodiments of the present disclosure, the network-side device may determine a terminal group, or an area, or a moving speed of the terminal based on the indication information sent by the terminal.

In the embodiments of the present disclosure, the network-side device receives the indication information sent by the terminal, where the indication information is used to indicate the geographical location of the terminal. Thus, the network-side device may determine whether the terminal meets the specific conditions, such as whether it belongs to a specific cell, a specific area, or a specific terminal group.

In the embodiments of the present disclosure, the network-side device receives the indication information sent by the terminal, where the indication information is used to indicate the area identifier of the terminal. Thus, the network-side device may determine whether the terminal meets the specific conditions, such as whether it belongs to a specific cell, a specific area, or a specific terminal group.

In the embodiments of the present disclosure, the network-side device receives the indication information sent by the terminal, where the indication information is used to indicate the time-domain channel characteristics reported by the terminal. Thus, the network-side device may determine whether the terminal meets the specific conditions, such as whether it belongs to a specific cell, a specific area, or a specific terminal group.

In the embodiments of the present disclosure, the network-side device receives the indication information sent by the terminal, where the indication information is used to indicate the time-domain correlation of the terminal. Thus, the network-side device may determine whether the terminal meets the specific conditions, such as whether it belongs to a specific cell, a specific area, or a specific terminal group.

In the embodiments of the present disclosure, the network-side device sends the reference signal to the terminal meeting the specific conditions, where the reference signal is used to instruct the terminal meeting the specific conditions to collect the first data information based on the reference signal and send it to the network-side device. The network-side device may receive the first data information sent by the terminal to perform a model processing of the CSI generation model and/or the CSI recovery model or calculate CST based on the first data information.

It should be noted that in the embodiments of the present disclosure, S41 may be implemented alone or in combination with any other step in the embodiments of the present disclosure, such as in combination with S31 in the embodiments of the present disclosure. The embodiments of the present disclosure do not limit this.

By implementing the embodiments of the present disclosure, the network-side device sends the reference signal to the terminal meeting the specific conditions, where the reference signal is used to instruct the terminal meeting the specific conditions to collect the first data information based on the reference signal and send it to the network-side device. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

Please refer to FIG. 5, which is a flowchart of yet another method for collecting data in an embodiment of the present disclosure. As shown in FIG. 5, the method is performed by a network-side device and may include, but is not limited to, the following steps:

S51: receiving a sounding reference signal (SRS) sent by a terminal.

S52: estimating uplink channel information based on the SRS and calculate a CSI-RS port beam for transmitting CSI-RS.

S53: sending a beamformed CSI-RS to the terminal.

S54: receiving first data information sent by the terminal, where the first data information includes at least one of a port combination coefficient, a frequency-domain basis vector, or port selection indication information.

S55: calculating estimated downlink channel information based on the CSI-RS port beam and at least one of the port combination coefficient, frequency-domain basis vector, or port selection indication information, to perform a model processing of the CSI generation model and/or the CSI recovery model or calculate CSI based on the estimated downlink channel information.

In the embodiments of the present disclosure, the network-side device receives the SRS sent by the terminal, estimates the uplink channel information based on the SRS, and uses the reciprocity of the angle and delay of the uplink and downlink channels to obtain the angle and delay information of the downlink channel.

The network-side device may send the angle and delay information to the terminal through beamformed CSI-RS ports to obtain the combination coefficients corresponding to these ports. The CSI-RS port beam is determined by the network-side device based on the angle and delay information of the uplink channel.

The terminal receives the beamformed CSI-RS sent by the network-side device and may obtain the combination coefficients of the ports based on the beamformed CSI-RS. The terminal may send at least one of the port combination coefficients, frequency-domain basis vectors, or port selection indication information to the network-side device.

In the embodiments of the present disclosure, the network-side device may calculate the estimated downlink channel information based on the CSI-RS port beam and at least one of the port combination coefficients, frequency-domain basis vectors, or port selection indication information, to perform a model processing of the CSI generation model and/or the CSI recovery model or calculate CSI based on the estimated downlink channel information.

In some embodiments, the first data information includes at least one of the following:
FP data;
estimated downlink channel information;
a feature vector corresponding to downlink channel information;
input data during training of the CSI recovery model at the terminal;
output data during training of the CSI recovery model at the terminal;
codebook parameter information;
compressed estimated downlink channel information;
a compressed feature vector corresponding to downlink channel information;
compressed input data during training of the CSI recovery model at the terminal;
compressed output data during training of the CSI recovery model at the terminal; or
compressed codebook vector information.

In the embodiments of the present disclosure, the first data information includes FP data.

In the embodiments of the present disclosure, the first data information includes estimated downlink channel information.

In the embodiments of the present disclosure, the first data information includes a feature vector corresponding to downlink channel information.

In the embodiments of the present disclosure, the first data information includes input data during training of the CSI recovery model at the terminal.

In the embodiments of the present disclosure, the first data information includes output data during training of the CSI recovery model at the terminal.

In the embodiments of the present disclosure, the first data information includes codebook parameter information.

In the embodiments of the present disclosure, the first data information includes compressed estimated downlink channel information.

In the embodiments of the present disclosure, the first data information includes a compressed feature vector corresponding to downlink channel information.

In the embodiments of the present disclosure, the first data information includes compressed input data during training of the CSI recovery model at the terminal.

In the embodiments of the present disclosure, the first data information includes compressed output data during training of the CSI recovery model at the terminal.

In the embodiments of the present disclosure, the first data information includes compressed codebook vector information.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In some embodiments, when the network-side device trains the CSI recovery model based on the first data information, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

In the embodiments of the present disclosure, for Training Type 3, where the CSI generation model and the CSI recovery model are trained at the terminal and then the CSI recovery model is trained at the network-side device, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

It should be noted that in the embodiments of the present disclosure, S51 to S55 may be implemented alone or in combination with any other step in the embodiments of the present disclosure, such as in combination with S31 and/or S41 in the embodiments of the present disclosure. The embodiments of the present disclosure do not limit this.

By implementing the embodiments of the present disclosure, the network-side device receives the SRS sent by the terminal, estimates the uplink channel information based on the SRS, calculates the CSI-RS port beam for transmitting CSI-RS, sends the beamformed CSI-RS to the terminal, and receives the first data information sent by the terminal, where the first data information includes at least one of the port combination coefficients, frequency-domain basis vectors, or port selection indication information. The network-side device calculates the estimated downlink channel information based on the CSI-RS port beam and at least one of the port combination coefficients, frequency-domain basis vectors, or port selection indication information, to perform a model processing of the CSI generation model and/or the CSI recovery model or calculate CSI based on the estimated downlink channel information. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

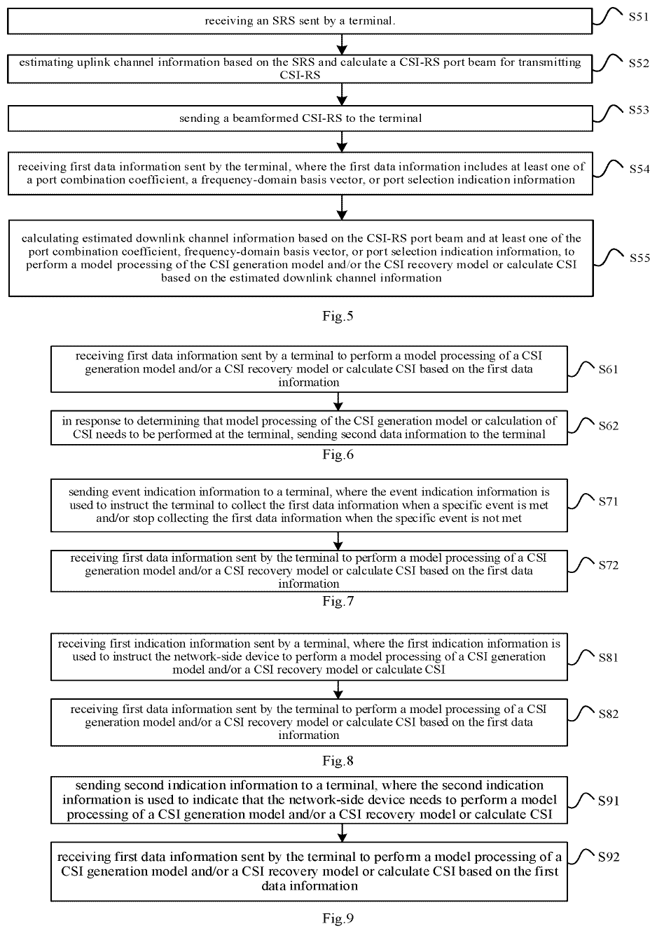

Please refer to FIG. 6, which is a flowchart of yet another method for collecting data in an embodiment of the present disclosure. As shown in FIG. 6, the method is performed by a network-side device and may include, but is not limited to, the following steps:

S61: receiving first data information sent by a terminal to perform a model processing of a CSI generation model and/or a CSI recovery model or calculate CSI based on the first data information.

The related description of S61 can be found in the relevant description in the above embodiments and will not be repeated here.

S62: in response to determining that model processing of the CSI generation model or calculation of CSI needs to be performed at the terminal, sending second data information to the terminal.

In the embodiments of the present disclosure, when the network-side device determines that model processing of the CSI generation model or calculation of CSI needs to be performed at the terminal, it may send the second data information to the terminal.

It should be understood that in Training Type 3, the CSI generation model and the CSI recovery model are trained at the network-side device, and then the network-side device sends the trained data or other auxiliary information to the terminal, and the model processing of the CSI generation model or calculation of CSI is performed at the terminal.

In the embodiments of the present disclosure, the network-side device may adopt the above Training Type 3 approach. After receiving the first data information sent by the terminal and performing model processing of the CSI generation model and/or the CSI recovery model or calculating CSI based on the first data information, the network-side device may send the second data information to the terminal.

In some embodiments, the network-side device sends the second data information to the terminal by broadcasting the second data information to the terminal.

The network-side device may send the second data information to the terminal by sending at least one of RRC signaling, MAC-CE, or DCI signaling, where the RRC signaling, MAC-CE, or DCI signaling includes the second data information.

In some embodiments, the second data information includes at least one of the following:
backward propagation (BP) data;
the identifier of the terminal;
input data during training of the CSI generation model at the network-side device;
output data during training of the CSI generation model at the network-side device.

In the embodiments of the present disclosure, the second data information includes BP data.

In the embodiments of the present disclosure, the second data information includes the identifier of the terminal.

In the embodiments of the present disclosure, the second data information includes input data during training of the CSI generation model at the network-side device.

In the embodiments of the present disclosure, the second data information includes output data during training of the CSI generation model at the network-side device.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In some embodiments, the second data information further includes second auxiliary information, where the second auxiliary information includes: preprocessing information of the CSI generation model or quantization method indication information output by the CSI generation model when the CSI generation model and the CSI recovery model are trained at the network-side device.

In the embodiments of the present disclosure, the second data information includes second auxiliary information, where the second auxiliary information includes: preprocessing information of the CSI generation model or quantization method indication information output by the CSI generation model when the CSI generation model and the CSI recovery model are trained at the network-side device.

In some embodiments, the quantization method indication information includes indication information using a uniform scalar quantization method, indication information using a non-uniform scalar quantization method, or indication information using a vector quantization method, where a vector quantization codebook is indicated when the vector quantization method is used.

It should be noted that in the embodiments of the present disclosure, S61 to S62 may be implemented alone or in combination with any other step in the embodiments of the present disclosure, such as in combination with S31 and/or S41 and/or S51 to S55 in the embodiments of the present disclosure. The embodiments of the present disclosure do not limit this.

By implementing the embodiments of the present disclosure, the network-side device receives the first data information sent by the terminal to perform a model processing of the CSI generation model and/or the CSI recovery model or calculate CSI based on the first data information. In response to determining that model processing of the CSI generation model or calculation of CSI needs to be performed at the terminal, the network-side device sends the second data information to the terminal. Thus, the network-side device can obtain the first data information for performing model processing of the CSI generation model and/or the CSI recovery model or calculating CSI, and the terminal can obtain the second data information for performing model processing of the CSI generation model or calculating CSI, thereby enabling online or offline training, inference, model monitoring, fine-tuning, and data analysis of the CSI generation model and/or the CSI recovery model.

Please refer to FIG. 7, which is a flowchart of yet another method for collecting data in an embodiment of the present disclosure. As shown in FIG. 7, the method is performed by a network-side device and may include, but is not limited to, the following steps:

S71: sending event indication information to a terminal, where the event indication information is used to instruct the terminal to collect the first data information when a specific event is met and/or stop collecting the first data information when the specific event is not met.

In the embodiments of the present disclosure, the network-side device may send event indication information to the terminal, where the event indication information is used to instruct the terminal to collect the first data information when a specific event is met and/or stop collecting the first data information when the specific event is not met.

The network-side device may send the event indication information to the terminal by sending at least one of RRC signaling, MAC-CE, or DCI signaling, where the RRC signaling, MAC-CE, or DCI signaling includes the event indication information.

S72: receiving first data information sent by the terminal to perform a model processing of a CSI generation model and/or a CSI recovery model or calculate CSI based on the first data information.

The related description of S72 can be found in the relevant description in the above embodiments and will not be repeated here.

It should be noted that in the embodiments of the present disclosure, S71 to S72 may be implemented alone or in combination with any other step in the embodiments of the present disclosure, such as in combination with S31 and/or S41 and/or S51 to S55 and/or S61 to S62 in the embodiments of the present disclosure. The embodiments of the present disclosure do not limit this.

By implementing the embodiments of the present disclosure, the network-side device sends event indication information to the terminal, where the event indication information is used to instruct the terminal to collect the first data information when a specific event is met and/or stop collecting the first data information when the specific event is not met. The network-side device receives the first data information sent by the terminal to perform a model processing of the CSI generation model and/or the CSI recovery model or calculate CSI based on the first data information. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

Please refer to FIG. 8, which is a flowchart of yet another method for collecting data in an embodiment of the present disclosure. As shown in FIG. 8, the method is performed by a network-side device and may include, but is not limited to, the following steps:

S81: receiving first indication information sent by a terminal, where the first indication information is used to instruct the network-side device to perform a model processing of a CSI generation model and/or a CSI recovery model or calculate CSI.

It should be understood that the network-side device may determine that model processing of the CSI generation model and/or the CSI recovery model or calculation of CSI needs to be performed at the network-side device based on an indication from the terminal.

In the embodiments of the present disclosure, the network-side device receives the first indication information sent by the terminal, where the first indication information instructs the network-side device to perform a model processing of the CSI generation model and/or the CSI recovery model or calculate CSI. Thus, the network-side device may determine that model processing of the CSI generation model and/or the CSI recovery model or calculation of CSI needs to be performed at the network-side device.

In an embodiment, the network-side device receives the first indication information sent by the terminal, where the first indication information is used to instruct the network-side device to perform a model processing of the CSI generation model and the CSI recovery model or calculate CSI.

In one possible implementation, the first indication information may indicate Training Type 1, where the CSI generation model and the CSI recovery model are trained at the network-side device. Based on this, after receiving the first indication information sent by the terminal, the network-side device may determine to use Training Type 1 and train the CSI generation model and the CSI recovery model at the network-side device.

In another possible implementation, the first indication information may indicate Training Type 3, where the CSI generation model and the CSI recovery model are first trained at the network-side device, and then the network-side device sends the dataset and/or other auxiliary information for training the CSI generation model to the terminal, and the CSI generation model is trained at the terminal. Based on this, after receiving the first indication information sent by the terminal, the network-side device may determine to use Training Type 3, train the CSI generation model and the CSI recovery model at the network-side device, and then send the dataset and/or other auxiliary information for training the CSI generation model to the terminal, so that the CSI generation model can be trained at the terminal.

In another embodiment, the network-side device receives the first indication information sent by the terminal, where the first indication information is used to instruct the network-side device to perform a model processing on the CSI recovery model or calculate CSI.

In one possible implementation, the first indication information may indicate Training Type 3, where the CSI generation model and the CSI recovery model are first trained at the terminal, and then the terminal sends the dataset and/or other auxiliary information for training the CSI recovery model to the network-side device. Based on this, after receiving the first indication information sent by the terminal, the network-side device may determine to perform a model processing on the CSI recovery model or calculate CSI at the network-side device.

In another possible implementation, the first indication information may indicate Training Type 2, where the CSI generation model and the CSI recovery model are jointly trained at the terminal and the network-side device, respectively, with the CSI generation model trained at the terminal and the CSI recovery model trained at the network-side device. Based on this, after receiving the first indication information sent by the terminal, the network-side device may determine to perform a model processing on the CSI recovery model or calculate CSI at the network-side device.

S82: receiving first data information sent by the terminal to perform a model processing of a CSI generation model and/or a CSI recovery model or calculate CSI based on the first data information.

The related description of S82 can be found in the relevant description in the above embodiments and will not be repeated here.

It should be noted that in the embodiments of the present disclosure, S81 to S82 may be implemented alone or in combination with any other step in the embodiments of the present disclosure, such as in combination with S31 and/or S41 and/or S51 to S55 and/or S61 to S62 and/or S71 to S72 in the embodiments of the present disclosure. The embodiments of the present disclosure do not limit this.

By implementing the embodiments of the present disclosure, the network-side device receives the first indication information sent by the terminal, where the first indication information is used to instruct the network-side device to perform a model processing of the CSI generation model and/or the CSI recovery model or calculate CSI. The network-side device receives the first data information sent by the terminal to perform a model processing of the CSI generation model and/or the CSI recovery model or calculate CSI based on the first data information. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

Please refer to FIG. 9, which is a flowchart of yet another method for collecting data in an embodiment of the present disclosure. As shown in FIG. 9, the method is performed by a network-side device and may include, but is not limited to, the following steps:

S91: sending second indication information to a terminal, where the second indication information is used to indicate that the network-side device needs to perform a model processing of a CSI generation model and/or a CSI recovery model or calculate CSI.

In the embodiments of the present disclosure, the network-side device sends the second indication information to the terminal, where the second indication information is used to indicate that the network-side device needs to perform a model processing of the CSI generation model and/or the CSI recovery model or calculate CSI. Based on this, the terminal may determine that the network-side device needs to perform a model processing of the CSI generation model and/or the CSI recovery model or calculate CSI. In this case, the terminal may send the first data information to the network-side device according to the second indication information, so that the network-side device can perform a model processing of the CSI generation model and/or the CSI recovery model or calculate CSI based on the first data information.

It should be understood that when the network-side device receives the first data information actively reported by the terminal, the terminal may determine on its own that the network-side device needs to perform a model processing of the CSI generation model and/or the CSI recovery model or calculate CSI, and in this case, send the first data information to the network-side device.

The network-side device may send the second indication information to the terminal by sending at least one of RRC signaling, MAC-CE, or DCI signaling, where at least one of the RRC signaling, MAC-CE, or DCI signaling includes the second indication information.

In an embodiment, the network-side device sends the second indication information to the terminal, where the second indication information is used to indicate that the network-side device needs to perform a model processing of the CSI generation model and the CSI recovery model or calculate CSI.

In one possible implementation, the second indication information may indicate Training Type 1, where the CSI generation model and the CSI recovery model are trained at the network-side device. Based on this, after receiving the second indication information sent by the network-side device, the terminal may send the first data information to the network-side device, so that the network-side device can perform a model processing of the CSI generation model and the CSI recovery model or calculate CSI based on the first data information.

In another possible implementation, the second indication information may indicate Training Type 3, where the CSI generation model and the CSI recovery model are first trained at the network-side device, and then the network-side device sends the dataset and/or other auxiliary information for training the CSI generation model to the terminal, and the CSI generation model is trained at the terminal. Based on this, after receiving the second indication information sent by the network-side device, the terminal may send the first data information to the network-side device, so that the network-side device can perform a model processing of the CSI generation model and the CSI recovery model or calculate CSI based on the first data information.

In another embodiment, the network-side device sends the second indication information to the terminal, where the second indication information is used to indicate that the network-side device needs to perform a model processing on the CSI recovery model or calculate CSI.

In one possible implementation, the second indication information may indicate using Training Type 3 for training the model, where the CSI generation model and the CSI recovery model are first trained at the terminal, and then the terminal sends the dataset and/or other auxiliary information for training the CSI recovery model to the network-side device. The second indication information may be used to instruct the terminal to send the dataset and/or other auxiliary information for training the CSI recovery model to the network-side device. Based on this, after receiving the second indication information sent by the network-side device, the terminal may send the first data information to the network-side device, so that the network-side device can perform a model processing on the CSI recovery model or calculate CSI based on the first data information.

In another possible implementation, the second indication information may indicate Training Type 2, where the CSI generation model and the CSI recovery model are jointly trained at the terminal and the network-side device, respectively, with the CSI generation model trained at the terminal and the CSI recovery model trained at the network-side device. Based on this, after receiving the second indication information sent by the network-side device, the terminal may send the first data information to the network-side device, so that the network-side device can perform a model processing on the CSI recovery model or calculate CSI based on the first data information.

S92: receiving first data information sent by the terminal to perform a model processing of a CST generation model and/or a CST recovery model or calculate CSI based on the first data information.

The related description of S92 can be found in the relevant description in the above embodiments and will not be repeated here.

It should be noted that in the embodiments of the present disclosure, S91 to S92 may be implemented alone or in combination with any other step in the embodiments of the present disclosure, such as in combination with S31 and/or S41 and/or S51 to S55 and/or S61 to S62 and/or S71 to S72 and/or S81 to S82 in the embodiments of the present disclosure. The embodiments of the present disclosure do not limit this.

By implementing the embodiments of the present disclosure, the network-side device sends the second indication information to the terminal, where the second indication information is used to indicate that the network-side device needs to perform a model processing of the CSI generation model and/or the CSI recovery model or calculate CSI. The network-side device receives the first data information sent by the terminal to perform a model processing of the CSI generation model and/or the CSI recovery model or calculate CSI based on the first data information. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

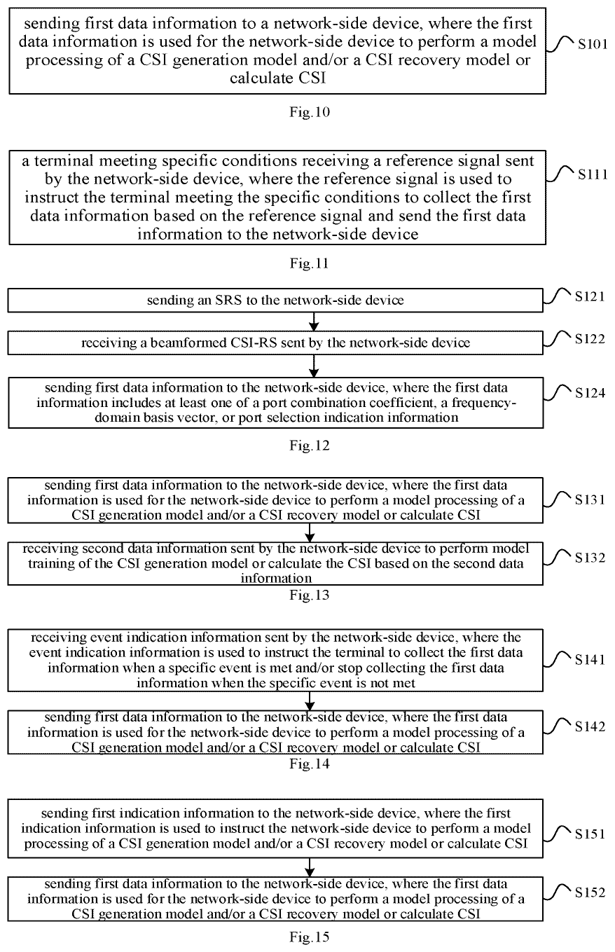

Please refer to FIG. 10, which is a flowchart of yet another method for collecting data in an embodiment of the present disclosure. As shown in FIG. 10, the method is performed by a terminal and may include, but is not limited to, the following steps:

S101: sending first data information to a network-side device, where the first data information is used for the network-side device to perform a model processing of a CST generation model and/or a CSI recovery model or calculate CSI.

In the embodiments of the present disclosure, the terminal may send the first data information to the network-side device. The terminal may actively report the first data information or may report the first data information based on a specific indication sent by the network-side-side device.

In some embodiments, the terminal sends the first data information to the network-side device through uplink data transmission or uplink control information (UCI).

It should be understood that when the network-side device determines that model processing of the CSI generation model and/or the CSI recovery model or calculation of CSI needs to be performed at the network-side device, it may send a specific indication to the terminal.

In some embodiments, the terminal receives second indication information sent by the network-side device, where the second indication information is used to indicate that the network-side device needs to perform a model processing of the CSI generation model and/or the CSI recovery model or calculate CSI.

In the embodiments of the present disclosure, the terminal receives the second indication information sent by the network-side device, where the second indication information is used to indicate that the network-side device needs to perform a model processing of the CSI generation model and/or the CSI recovery model or calculate CSI. Based on this, the terminal may determine that the network-side device needs to perform a model processing of the CSI generation model and/or the CSI recovery model or calculate CSI, and in this case, send the first data information to the network-side device according to the second indication information.

It should be understood that when the terminal actively reports the first data information, it may determine on its own that the network-side device needs to perform a model processing of the CSI generation model and/or the CSI recovery model or calculate CSI, and in this case, send the first data information to the network-side device.

It should also be understood that the network-side device may determine that model processing of the CSI generation model and/or the CSI recovery model or calculation of CSI needs to be performed at the network-side device based on protocol agreements, or may determine it on its own, or may determine it based on an indication from the terminal.

In some embodiments, the terminal sends first indication information to the network-side device, where the first indication information is used to instruct the network-side device to perform a model processing of the CSI generation model and/or the CSI recovery model or calculate CSI.

In the embodiments of the present disclosure, the terminal sends the first indication information to the network-side device, where the first indication information instructs the network-side device to perform a model processing of the CSI generation model and/or the CSI recovery model or calculate CSI. Thus, the network-side device may determine that model processing of the CSI generation model and/or the CSI recovery model or calculation of CSI needs to be performed at the network-side device.

In some embodiments, the first data information includes at least one of the following:
forward propagation (FP) data;
estimated downlink channel information;
a feature vector corresponding to downlink channel information;
input data during training of the CSI recovery model at the terminal;
output data during training of the CSI recovery model at the terminal;
codebook parameter information;
compressed estimated downlink channel information;
a compressed feature vector corresponding to downlink channel information;
compressed input data during training of the CSI recovery model at the terminal;
compressed output data during training of the CSI recovery model at the terminal; or
compressed codebook vector information.

In the embodiments of the present disclosure, the first data information includes FP data.

In the embodiments of the present disclosure, the first data information includes estimated downlink channel information.

In the embodiments of the present disclosure, the first data information includes a feature vector corresponding to downlink channel information.

In the embodiments of the present disclosure, the first data information includes input data during training of the CSI recovery model at the terminal.

In the embodiments of the present disclosure, the first data information includes output data during training of the CSI recovery model at the terminal.

In the embodiments of the present disclosure, the first data information includes codebook parameter information.

In the embodiments of the present disclosure, the first data information includes compressed estimated downlink channel information.

In the embodiments of the present disclosure, the first data information includes a compressed feature vector corresponding to downlink channel information.

In the embodiments of the present disclosure, the first data information includes compressed input data during training of the CSI recovery model at the terminal.

In the embodiments of the present disclosure, the first data information includes compressed output data during training of the CSI recovery model at the terminal.

In the embodiments of the present disclosure, the first data information includes compressed codebook vector information.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In an embodiment, the terminal sends the first data information to the network-side device, where the first data information includes compressed estimated downlink channel information. The terminal is deployed with a reference CSI generation model and/or a reference CSI recovery model, which can compress the estimated downlink channel information of the terminal to obtain compressed estimated downlink channel information and send the compressed estimated downlink channel information to the network-side device.

In another embodiment, the terminal sends the first data information to the network-side device, where the first data information includes a compressed feature vector corresponding to downlink channel information. The terminal is deployed with a reference CSI generation model and/or a reference CSI recovery model, which can compress the feature vector corresponding to the downlink channel information to obtain a compressed feature vector and send the compressed feature vector to the network-side device.

In another embodiment, the terminal sends the first data information to the network-side device, where the first data information includes compressed input data during training of the CSI recovery model at the terminal. The terminal is deployed with a reference CSI generation model and/or a reference CSI recovery model, which can compress the input data during training of the CSI recovery model at the terminal to obtain compressed input data and send the compressed input data to the network-side device.

In another embodiment, the terminal sends the first data information to the network-side device, where the first data information includes compressed output data during training of the CSI recovery model at the terminal. The terminal is deployed with a reference CSI generation model and/or a reference CSI recovery model, which can compress the output data during training of the CSI recovery model at the terminal to obtain compressed output data and send the compressed output data to the network-side device.

In another embodiment, the terminal sends the first data information to the network-side device, where the first data information includes compressed codebook vector information. The terminal is deployed with a reference CSI generation model and/or a reference CSI recovery model, which can compress the codebook vector information to obtain compressed codebook vector information and send the compressed codebook vector information to the network-side device.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In some embodiments, the terminal receives event indication information sent by the network-side device, where the event indication information is used to instruct the terminal to collect the first data information when a specific event is met and/or stop collecting the first data information when the specific event is not met.

In the embodiments of the present disclosure, the terminal may receive event indication information sent by the network-side device, where the event indication information is used to instruct the terminal to collect the first data information when a specific event is met and/or stop collecting the first data information when the specific event is not met.

In some embodiments, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

In the embodiments of the present disclosure, in Training Type 3, where the CSI generation model and the CSI recovery model are trained at the terminal and the CSI recovery model is trained at the network-side device, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

In the embodiments of the present disclosure, the terminal may send the first data information to the network-side device, and the network-side device may perform a model processing of the CSI generation model and/or the CSI recovery model based on the first data information, enabling online or offline training, fine-tuning, and monitoring of the CSI generation model and/or the CSI recovery model at the network-side device, etc.

In the embodiments of the present disclosure, the terminal may send the first data information to the network-side device, and the network-side device may calculate CSI based on the first data information, enabling inference, monitoring, and data analysis of the CSI generation model and/or the CSI recovery model at the network-side device.

By implementing the embodiments of the present disclosure, the terminal sends the first data information to the network-side device, where the first data information is used for the network-side device to perform a model processing of the CSI generation model and/or the CSI recovery model or calculate CSI. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

Please refer to FIG. 11, which is a flowchart of yet another method for collecting data in an embodiment of the present disclosure. As shown in FIG. 11, the method is performed by a terminal and may include, but is not limited to, the following steps:

S111: a terminal meeting specific conditions receiving a reference signal sent by the network-side device, where the reference signal is used to instruct the terminal meeting the specific conditions to collect the first data information based on the reference signal and send the first data information to the network-side device.

In the embodiments of the present disclosure, a cell-specific reference signal is designed, enabling terminals within a specific cell to complete the collection of the first data information based on the cell-specific reference signal sent by the network-side device and send the first data information to the network-side device.

Alternatively, a terminal group-specific or area-specific reference signal may be designed, enabling terminals within a specific terminal group or area to complete the collection of the first data information based on the reference signal and then send the collected first data information to the network-side device.

In the embodiments of the present disclosure, the network-side device sends the reference signal to the terminal meeting the specific conditions, where the reference signal is used to instruct the terminal meeting the specific conditions to collect the first data information based on the reference signal and send it to the network-side device. Thus, after receiving the reference signal, the terminal meeting the specific conditions can collect the first data information and send it to the network-side device.

In some embodiments, the specific conditions include at least one of the following:
the terminal belonging to a specific cell;
the terminal belonging to a specific terminal group;
the terminal belonging to a specific area.

In the embodiments of the present disclosure, the specific conditions include belonging to a specific cell, and the terminal meeting the specific conditions may be a terminal belonging to the specific cell.

In the embodiments of the present disclosure, the specific conditions include belonging to a specific terminal group, and the terminal meeting the specific conditions may be a terminal belonging to the specific terminal group.

In the embodiments of the present disclosure, the specific conditions include belonging to a specific area, and the terminal meeting the specific conditions may be a terminal belonging to the specific area.

In some embodiments, the first data information includes at least one of the following:
FP data;
estimated downlink channel information;
a feature vector corresponding to downlink channel information;
input data during training of the CSI recovery model at the terminal;
output data during training of the CSI recovery model at the terminal;
codebook parameter information;
compressed estimated downlink channel information;
a compressed feature vector corresponding to downlink channel information;
compressed input data during training of the CSI recovery model at the terminal;
compressed output data during training of the CSI recovery model at the terminal;
compressed codebook vector information.

In the embodiments of the present disclosure, the first data information includes FP data.

In the embodiments of the present disclosure, the first data information includes estimated downlink channel information.

In the embodiments of the present disclosure, the first data information includes a feature vector corresponding to downlink channel information.

In the embodiments of the present disclosure, the first data information includes input data during training of the CSI recovery model at the terminal.

In the embodiments of the present disclosure, the first data information includes output data during training of the CSI recovery model at the terminal.

In the embodiments of the present disclosure, the first data information includes codebook parameter information.

In the embodiments of the present disclosure, the first data information includes compressed estimated downlink channel information.

In the embodiments of the present disclosure, the first data information includes a compressed feature vector corresponding to downlink channel information.

In the embodiments of the present disclosure, the first data information includes compressed input data during training of the CSI recovery model at the terminal.

In the embodiments of the present disclosure, the first data information includes compressed output data during training of the CSI recovery model at the terminal.

In the embodiments of the present disclosure, the first data information includes compressed codebook vector information.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In an embodiment, the first data information includes estimated downlink channel information. After receiving the reference signal sent by the network-side device, the terminal may estimate the downlink channel to obtain the estimated downlink channel information and send the estimated downlink channel information to the network-side device.

The terminal may report the estimated downlink channel information to the network-side device through CSI.

In another embodiment, the first data information includes a feature vector corresponding to downlink channel information. After receiving the reference signal sent by the network-side device, the terminal may estimate the downlink channel to obtain the feature vector corresponding to the estimated downlink channel information and send the feature vector corresponding to the downlink channel information to the network-side device.

The terminal may report the feature vector corresponding to the downlink channel information to the network-side device through CSI.

In another embodiment, the first data information includes compressed estimated downlink channel information or a compressed feature vector corresponding to downlink channel information. After receiving the reference signal sent by the network-side device, the terminal may estimate the downlink channel to obtain the estimated downlink channel information or the feature vector corresponding to the downlink channel information. The terminal may compress the obtained estimated downlink channel information or the feature vector corresponding to the downlink channel information to obtain the compressed estimated downlink channel information or compressed feature vector corresponding to the downlink channel information and then send it to the network-side device.

After receiving the compressed estimated downlink channel information or compressed feature vector corresponding to the downlink channel information sent by the terminal, the network-side device may recover the pre-compression estimated downlink channel information or pre-compression feature vector corresponding to the downlink channel information. Based on this, the network-side device may perform a model processing of the CSI generation model and/or the CSI recovery model or calculate CSI based on the estimated downlink channel information or feature vector.

In another embodiment, a reference CSI generation part model is deployed at the terminal, and a reference CSI recovery part model is deployed at the network-side device. The reference CSI generation part model at the terminal is used to compress the estimated downlink channel information of the terminal or to compress the feature vector corresponding to the downlink channel information or Type II codebook vector and then send it to the network-side device. The reference CSI recovery part model at the network-side device may recover the compressed estimated downlink channel information sent by the terminal to obtain the estimated downlink channel information or recover the compressed feature vector corresponding to the downlink channel information or Type II codebook vector sent by the terminal to obtain the feature vector corresponding to the downlink channel information or Type II codebook vector.

It should be noted that the above examples are only illustrative and do not specifically limit the embodiments of the present disclosure. The content included in the first data information may also be other data information. The terminal may perform corresponding processing to obtain the first data information, and the network-side device may perform corresponding processing on the first data information to perform a model processing of the CSI generation model and/or the CSI recovery model or calculate CSI based on the first data information.

In some embodiments, the terminal sends indication information to the network-side device, where the indication information is used to indicate at least one of the following:
the geographical location of the terminal;
the area identifier of the terminal;
the time-domain channel characteristics reported by the terminal; or
the time-domain correlation of the terminal.

In the embodiments of the present disclosure, the terminal sends the indication information to the network-side device, where the indication information is used to indicate the geographical location of the terminal.

In the embodiments of the present disclosure, the terminal sends the indication information to the network-side device, where the indication information is used to indicate the area identifier of the terminal.

In the embodiments of the present disclosure, the terminal sends the indication information to the network-side device, where the indication information is used to indicate the time-domain channel characteristics reported by the terminal.

In the embodiments of the present disclosure, the terminal sends the indication information to the network-side device, where the indication information is used to indicate the time-domain correlation of the terminal.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

It should be noted that in the embodiments of the present disclosure, S111 may be implemented alone or in combination with any other step in the embodiments of the present disclosure, such as in combination with S101 in the embodiments of the present disclosure. The embodiments of the present disclosure do not limit this.

By implementing the embodiments of the present disclosure, the terminal meeting the specific conditions receives the reference signal sent by the network-side device, where the reference signal is used to instruct the terminal meeting the specific conditions to collect the first data information based on the reference signal and send it to the network-side device. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

Please refer to FIG. 12, which is a flowchart of yet another method for collecting data in an embodiment of the present disclosure. As shown in FIG. 12, the method is performed by a terminal and may include, but is not limited to, the following steps:

S121: sending an SRS to the network-side device.

S122: receiving a beamformed CSI-RS sent by the network-side device.

S123: sending first data information to the network-side device, where the first data information includes at least one of a port combination coefficient, a frequency-domain basis vector, or port selection indication information.

In the embodiments of the present disclosure, the network-side device receives the SRS sent by the terminal, estimates the uplink channel information based on the SRS, and uses the reciprocity of the angle and delay of the uplink and downlink channels to obtain the angle and delay information of the downlink channel.

The network-side device may send the angle and delay information to the terminal through beamformed CSI-RS ports to obtain the combination coefficients corresponding to these ports. The CSI-RS port beam is determined by the network-side device based on the angle and delay information of the uplink channel.

The terminal receives the beamformed CSI-RS sent by the network-side device and may obtain the combination coefficients of the ports based on the beamformed CSI-RS. The terminal may send at least one of the port combination coefficients, frequency-domain basis vectors, or port selection indication information to the network-side device.

In the embodiments of the present disclosure, the network-side device may calculate the estimated downlink channel information based on the CSI-RS port beam and at least one of the port combination coefficients, frequency-domain basis vectors, or port selection indication information, to perform a model processing of the CSI generation model and/or the CSI recovery model or calculate CSI based on the estimated downlink channel information.

In some embodiments, the first data information includes at least one of the following:
FP data;
estimated downlink channel information;
a feature vector corresponding to downlink channel information;
input data during training of the CSI recovery model at the terminal;
output data during training of the CSI recovery model at the terminal;
codebook parameter information;
compressed estimated downlink channel information;
a compressed feature vector corresponding to downlink channel information;
compressed input data during training of the CSI recovery model at the terminal;
compressed output data during training of the CSI recovery model at the terminal; or
compressed codebook vector information.

In the embodiments of the present disclosure, the first data information includes FP data.

In the embodiments of the present disclosure, the first data information includes estimated downlink channel information.

In the embodiments of the present disclosure, the first data information includes a feature vector corresponding to downlink channel information.

In the embodiments of the present disclosure, the first data information includes input data during training of the CSI recovery model at the terminal.

In the embodiments of the present disclosure, the first data information includes output data during training of the CSI recovery model at the terminal.

In the embodiments of the present disclosure, the first data information includes codebook parameter information.

In the embodiments of the present disclosure, the first data information includes compressed estimated downlink channel information.

In the embodiments of the present disclosure, the first data information includes a compressed feature vector corresponding to downlink channel information.

In the embodiments of the present disclosure, the first data information includes compressed input data during training of the CSI recovery model at the terminal.

In the embodiments of the present disclosure, the first data information includes compressed output data during training of the CSI recovery model at the terminal.

In the embodiments of the present disclosure, the first data information includes compressed codebook vector information.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In some embodiments, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

In the embodiments of the present disclosure, for Training Type 3, where the CSI generation model and the CSI recovery model are trained at the terminal and then the CSI recovery model is trained at the network-side device, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

It should be noted that in the embodiments of the present disclosure, S121 to S123 may be implemented alone or in combination with any other step in the embodiments of the present disclosure, such as in combination with S101 and/or S111 in the embodiments of the present disclosure. The embodiments of the present disclosure do not limit this.

By implementing the embodiments of the present disclosure, the terminal sends the SRS to the network-side device, receives the beamformed CSI-RS sent by the network-side device, and sends the first data information to the network-side device, where the first data information includes at least one of the port combination coefficients, frequency-domain basis vectors, or port selection indication information. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

Please refer to FIG. 13, which is a flowchart of yet another method for collecting data in an embodiment of the present disclosure. As shown in FIG. 13, the method is performed by a terminal and may include, but is not limited to, the following steps:

S131: sending first data information to the network-side device, where the first data information is used for the network-side device to perform a model processing of a CSI generation model and/or a CSI recovery model or calculate CSI.

The related description of S131 can be found in the relevant description in the above embodiments and will not be repeated here.

S132: receiving second data information sent by the network-side device to perform model training of the CSI generation model or calculate the CSI based on the second data information.

In the embodiments of the present disclosure, the terminal may receive the second data information sent by the network-side device. When the network-side device determines that model processing of the CSI generation model or calculation of CSI needs to be performed at the terminal, it may send the second data information to the terminal.

It should be understood that in Training Type 3, the CSI generation model and the CSI recovery model are trained at the network-side device, and then the network-side device sends the trained data or other auxiliary information to the terminal, and the model processing of the CSI generation model or calculation of CSI is performed at the terminal.

In the embodiments of the present disclosure, the network-side device may adopt the above Training Type 3 approach. After receiving the first data information sent by the terminal and performing model processing of the CSI generation model and/or the CSI recovery model or calculating CSI based on the first data information, the network-side device may send the second data information to the terminal.

In some embodiments, the terminal receives the second data information sent by the network-side device by receiving the second data information broadcasted by the network-side device.

In some embodiments, the terminal receives the second data information sent by the network-side device by receiving RRC signaling sent by the network-side device, where the RRC signaling includes the second data information.

In some embodiments, the second data information includes at least one of the following:
BP data;
the identifier of the terminal;
input data during training of the CSI generation model at the network-side device;
output data during training of the CSI generation model at the network-side device.

In the embodiments of the present disclosure, the second data information includes BP data.

In the embodiments of the present disclosure, the second data information includes the identifier of the terminal.

In the embodiments of the present disclosure, the second data information includes input data during training of the CSI generation model at the network-side device.

In the embodiments of the present disclosure, the second data information includes output data during training of the CSI generation model at the network-side device.

It should be noted that the above embodiments are not exhaustive and are only illustrative of some embodiments. The above embodiments may be implemented alone or in combination with multiple embodiments. The above embodiments are only illustrative and do not specifically limit the scope of protection of the embodiments of the present disclosure.

In some embodiments, the second data information further includes second auxiliary information, where the second auxiliary information includes: preprocessing information of the CSI generation model or quantization method indication information output by the CSI generation model when the CSI generation model and the CSI recovery model are trained at the network-side device.

In the embodiments of the present disclosure, the second data information includes second auxiliary information, where the second auxiliary information includes: preprocessing information of the CSI generation model or quantization method indication information output by the CSI generation model when the CSI generation model and the CSI recovery model are trained at the network-side device.

It should be noted that in the embodiments of the present disclosure, S131 to S132 may be implemented alone or in combination with any other step in the embodiments of the present disclosure, such as in combination with S101 and/or S111 and/or S121 to S123 in the embodiments of the present disclosure. The embodiments of the present disclosure do not limit this.

By implementing the embodiments of the present disclosure, the terminal sends the first data information to the network-side device, where the first data information is used for the network-side device to perform a model processing of the CSI generation model and/or the CSI recovery model or calculate CSI. The terminal receives the second data information sent by the network-side device to perform model training of the CSI generation model or calculate the CSI based on the second data information. Thus, the network-side device can obtain the first data information for performing model processing of the CSI generation model and/or the CSI recovery model or calculating CSI, and the terminal can obtain the second data information for performing model processing of the CSI generation model or calculating CSI, thereby enabling online or offline training, inference, model monitoring, fine-tuning, and data analysis of the CSI generation model and/or the CSI recovery model.

Please refer to FIG. 14, which is a flowchart of yet another method for collecting data in an embodiment of the present disclosure. As shown in FIG. 14, the method is performed by a terminal and may include, but is not limited to, the following steps:

S141: receiving event indication information sent by the network-side device, where the event indication information is used to instruct the terminal to collect the first data information when a specific event is met and/or stop collecting the first data information when the specific event is not met.

In the embodiments of the present disclosure, the terminal may receive event indication information sent by the network-side device, where the event indication information is used to instruct the terminal to collect the first data information when a specific event is met and/or stop collecting the first data information when the specific event is not met.

In some embodiments, the terminal receives the event indication information sent by the network-side device by receiving at least one of RRC signaling, MAC-CE, or DCI signaling sent by the network-side device, where at least one of the RRC signaling, MAC-CE, or DCI signaling includes the event indication information.

S142: sending first data information to the network-side device, where the first data information is used for the network-side device to perform a model processing of a CSI generation model and/or a CSI recovery model or calculate CSI.

The related description of S142 can be found in the relevant description in the above embodiments and will not be repeated here.

It should be noted that in the embodiments of the present disclosure, S141 to S142 may be implemented alone or in combination with any other step in the embodiments of the present disclosure, such as in combination with S101 and/or S111 and/or S121 to S123 and/or S131 to S132 in the embodiments of the present disclosure. The embodiments of the present disclosure do not limit this.

By implementing the embodiments of the present disclosure, the terminal receives the event indication information sent by the network-side device, where the event indication information is used to instruct the terminal to collect the first data information when a specific event is met and/or stop collecting the first data information when the specific event is not met. The terminal sends the first data information to the network-side device, where the first data information is used for the network-side device to perform a model processing of the CSI generation model and/or the CSI recovery model or calculate CSI. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

Please refer to FIG. 15, which is a flowchart of yet another method for collecting data in an embodiment of the present disclosure. As shown in FIG. 15, the method is performed by a terminal and may include, but is not limited to, the following steps:

S151: sending first indication information to the network-side device, where the first indication information is used to instruct the network-side device to perform a model processing of a CSI generation model and/or a CSI recovery model or calculate CSI.

It should be understood that the network-side device may determine that model processing of the CSI generation model and/or the CSI recovery model or calculation of CSI needs to be performed at the network-side device based on an indication from the terminal.

In the embodiments of the present disclosure, the terminal sends the first indication information to the network-side device, where the first indication information instructs the network-side device to perform a model processing of the CSI generation model and/or the CSI recovery model or calculate CSI. Thus, the network-side device may determine that model processing of the CSI generation model and/or the CSI recovery model or calculation of CSI needs to be performed at the network-side device.

In an embodiment, the network-side device receives the first indication information sent by the terminal, where the first indication information is used to instruct the network-side device to perform a model processing of the CSI generation model and the CSI recovery model or calculate CSI.

In one possible implementation, the first indication information may indicate Training Type 1, where the CSI generation model and the CSI recovery model are trained at the network-side device. Based on this, after receiving the first indication information sent by the terminal, the network-side device may determine to use Training Type 1 and train the CSI generation model and the CSI recovery model at the network-side device.

In another possible implementation, the first indication information may indicate Training Type 3, where the CSI generation model and the CSI recovery model are first trained at the network-side device, and then the network-side device sends the dataset and/or other auxiliary information for training the CSI generation model to the terminal, and the CSI generation model is trained at the terminal. Based on this, after receiving the first indication information sent by the terminal, the network-side device may determine to use Training Type 3, train the CSI generation model and the CSI recovery model at the network-side device, and then send the dataset and/or other auxiliary information for training the CSI generation model to the terminal, so that the CSI generation model can be trained at the terminal.

In another embodiment, the network-side device receives the first indication information sent by the terminal, where the first indication information is used to instruct the network-side device to perform a model processing on the CSI recovery model or calculate CSI.

In one possible implementation, the first indication information may indicate Training Type 3, where the CSI generation model and the CSI recovery model are first trained at the terminal, and then the terminal sends the dataset and/or other auxiliary information for training the CSI recovery model to the network-side device. Based on this, after receiving the first indication information sent by the terminal, the network-side device may determine to perform a model processing on the CSI recovery model or calculate CSI at the network-side device.

In another possible implementation, the first indication information may indicate Training Type 2, where the CSI generation model and the CSI recovery model are jointly trained at the terminal and the network-side device, respectively, with the CSI generation model trained at the terminal and the CSI recovery model trained at the network-side device. Based on this, after receiving the first indication information sent by the terminal, the network-side device may determine to perform a model processing on the CSI recovery model or calculate CSI at the network-side device.

S152: sending first data information to the network-side device, where the first data information is used for the network-side device to perform a model processing of a CSI generation model and/or a CSI recovery model or calculate CSI.

The related description of S152 can be found in the relevant description in the above embodiments and will not be repeated here.

It should be noted that in the embodiments of the present disclosure, S151 to S152 may be implemented alone or in combination with any other step in the embodiments of the present disclosure, such as in combination with S101 and/or S11 and/or S121 to S123 and/or S131 to S132 and/or S141 to S142 in the embodiments of the present disclosure. The embodiments of the present disclosure do not limit this.

By implementing the embodiments of the present disclosure, the terminal sends the first indication information to the network-side device, where the first indication information is used to instruct the network-side device to perform a model processing of the CSI generation model and/or the CSI recovery model or calculate CSI. The terminal sends the first data information to the network-side device, where the first data information is used for the network-side device to perform a model processing of the CSI generation model and/or the CSI recovery model or calculate CSI. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

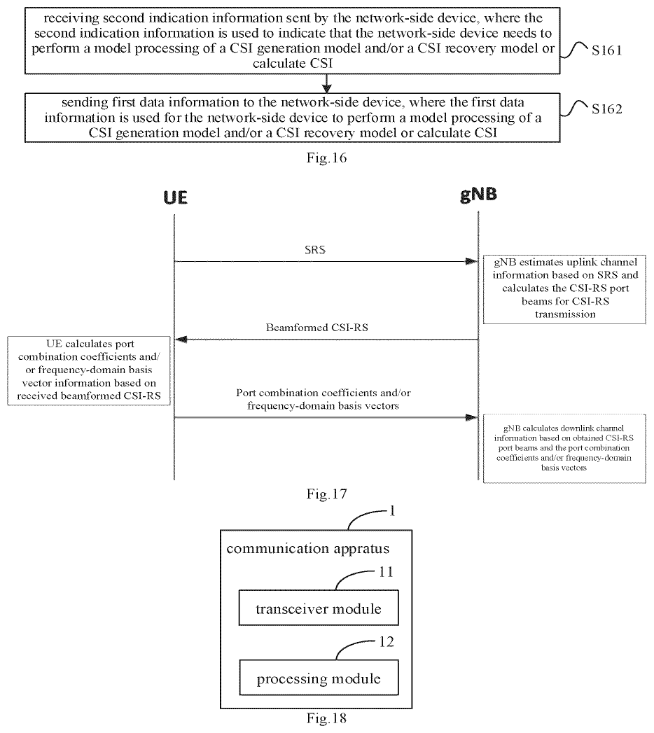

Please refer to FIG. 16, which is a flowchart of yet another method for collecting data in an embodiment of the present disclosure. As shown in FIG. 16, the method is performed by a terminal and may include, but is not limited to, the following steps:

S161: receiving second indication information sent by the network-side device, where the second indication information is used to indicate that the network-side device needs to perform a model processing of a CSI generation model and/or a CSI recovery model or calculate CSI.

In the embodiments of the present disclosure, the terminal receives the second indication information sent by the network-side device, where the second indication information is used to indicate that the network-side device needs to perform a model processing of the CSI generation model and/or the CSI recovery model or calculate CSI. Based on this, the terminal may determine that the network-side device needs to perform a model processing of the CSI generation model and/or the CSI recovery model or calculate CSI, and in this case, send the first data information to the network-side device according to the second indication information.

It should be understood that when the network-side device receives the first data information actively reported by the terminal, the terminal may determine on its own that the network-side device needs to perform a model processing of the CSI generation model and/or the CSI recovery model or calculate CSI, and in this case, send the first data information to the network-side device.

In some embodiments, the terminal receives the second indication information sent by the network-side device by receiving at least one of RRC signaling, MAC-CE, or DCI signaling sent by the network-side device, where the RRC signaling, MAC-CE, or DCI signaling includes the second indication information.

In an embodiment, the network-side device sends the second indication information to the terminal, where the second indication information is used to indicate that the network-side device needs to perform a model processing of the CSI generation model and the CSI recovery model or calculate CSI.

In one possible implementation, the second indication information may indicate Training Type 1, where the CSI generation model and the CSI recovery model are trained at the network-side device. Based on this, after receiving the second indication information sent by the network-side device, the terminal may send the first data information to the network-side device, so that the network-side device can perform a model processing of the CSI generation model and the CSI recovery model or calculate CSI based on the first data information.

In another possible implementation, the second indication information may indicate Training Type 3, where the CSI generation model and the CSI recovery model are first trained at the network-side device, and then the network-side device sends the dataset and/or other auxiliary information for training the CSI generation model to the terminal, and the CSI generation model is trained at the terminal. Based on this, after receiving the second indication information sent by the network-side device, the terminal may send the first data information to the network-side device, so that the network-side device can perform a model processing of the CSI generation model and the CSI recovery model or calculate CSI based on the first data information.

In another embodiment, the network-side device sends the second indication information to the terminal, where the second indication information is used to indicate that the network-side device needs to perform a model processing on the CSI recovery model or calculate CSI.

In one possible implementation, the second indication information may indicate Training Type 3, where the CSI generation model and the CSI recovery model are first trained at the terminal, and then the terminal sends the dataset and/or other auxiliary information for training the CSI recovery model to the network-side device. The second indication information may be used to instruct the terminal to send the dataset and/or other auxiliary information for training the CSI recovery model to the network-side device. Based on this, after receiving the second indication information sent by the network-side device, the terminal may send the first data information to the network-side device, so that the network-side device can perform a model processing on the CSI recovery model or calculate CSI based on the first data information.

In another possible implementation, the second indication information may indicate Training Type 2, where the CSI generation model and the CSI recovery model are jointly trained at the terminal and the network-side device, respectively, with the CSI generation model trained at the terminal and the CSI recovery model trained at the network-side device. Based on this, after receiving the second indication information sent by the network-side device, the terminal may send the first data information to the network-side device, so that the network-side device can perform a model processing on the CSI recovery model or calculate CSI based on the first data information.

S162: sending first data information to the network-side device, where the first data information is used for the network-side device to perform a model processing of a CSI generation model and/or a CSI recovery model or calculate CSI.

The related description of S162 can be found in the relevant description in the above embodiments and will not be repeated here.

It should be noted that in the embodiments of the present disclosure, S161 to S162 may be implemented alone or in combination with any other step in the embodiments of the present disclosure, such as in combination with S101 and/or S111 and/or S121 to S123 and/or S131 to S132 and/or S141 to S142 and/or S151 to S152 in the embodiments of the present disclosure. The embodiments of the present disclosure do not limit this.

By implementing the embodiments of the present disclosure, the terminal receives the second indication information sent by the network-side device, where the second indication information is used to indicate that the network-side device needs to perform a model processing of the CSI generation model and/or the CSI recovery model or calculate CSI. The terminal sends the first data information to the network-side device, where the first data information is used for the network-side device to perform a model processing of the CSI generation model and/or the CSI recovery model or calculate CSI. Thus, the network-side device can obtain the first data information for performing model processing of the CSI generation model and/or the CSI recovery model or calculating CSI, thereby enabling online or offline training, inference, model monitoring, fine-tuning, and data analysis of the CSI generation model and/or the CSI recovery model.

To facilitate understanding of the embodiments of the present disclosure, the following embodiments are provided.

In an embodiment, data collection by the network-side device includes:

Method 1: Design a cell-specific reference signal, enabling terminals within the cell to complete the collection of downlink channel information based on the reference signal. Alternatively, design a group-specific or area-specific reference signal, enabling terminals within the group or area to complete the collection of downlink channel information based on the reference signal. The terminals then send the collected downlink channel information dataset to the network-side device. Specifically, the implementation of data collection by the network-side device includes the following steps:

Step 1: the network-side device broadcasts the cell-specific or group/area-specific reference signal to the terminals.

Step 2: the terminals estimate the downlink channel information based on the reference signal.

Step 3: the terminals send the downlink channel information to the network-side device through the following methods:

Method 1 (Opt1): the terminal directly reports the estimated downlink channel information to the network-side device through CSI.

Method 2 (Opt2): the terminal converts the estimated downlink channel information into a feature vector or Type II codebook vector (e.g., Rel-16 Type II or Rel-17 Type II port selection codebook) and reports it to the network-side device through CSI.

Method 3 (Opt3): a reference CSI generation part model and a reference CSI recovery part model are deployed at the terminal and the network-side device, respectively. The reference CSI generation part model compresses the estimated downlink channel information or the feature vector/Type II codebook vector corresponding to the downlink channel information and sends it to the network-side device. The reference CSI recovery part model at the network-side device recovers the compressed downlink channel information or feature vector/Type II codebook vector to obtain an approximation of the original downlink channel information or feature vector/Type II codebook vector.

The grouping or area division method may be based on the geographical location of the terminal, the area ID, or the time-domain channel characteristics reported by the terminal (e.g., Doppler spread or time-domain correlation).

Method 2: Implement downlink channel information data collection based on uplink reference signals and terminal feedback information through the following three steps:

Step 1: the terminal sends an SRS to the network-side device. The network-side device estimates the uplink channel information based on the SRS and uses the reciprocity of the angle and delay of the uplink and downlink channels to obtain the angle and delay information of the downlink channel.

Step 2: the network-side device sends the angle and delay information to the terminal through beamformed CSI-RS ports to obtain the combination coefficients corresponding to these ports. The CSI-RS port beam is determined by the network-side device based on the angle and delay information of the uplink channel.

Step 3: the terminal calculates the combination coefficients of all or some CSI-RS ports based on the received beamformed CSI-RS and sends the combination coefficients or possible frequency-domain basis vector information to the network-side device.

Other possible first auxiliary information:

For Training Type 3 (UE-first training), where the terminal first trains the CSI generation part model and the CSI recovery part model and then sends the dataset and/or other auxiliary information for training the CSI recovery part model to the network-side device, the first auxiliary information includes preprocessing information output by the CSI recovery part model. Alternatively, the preprocessing information may be determined through predefined methods.

For Training Type 3 (NW-first training), where the network-side device first trains the CSI generation part model and the CSI recovery part model and then sends the dataset and/or other auxiliary information for training the CSI generation part model to the terminal, the second auxiliary information includes preprocessing information input to the CSI generation part model. Alternatively, the preprocessing information may be determined through predefined methods.

In an embodiment, data collection by the terminal includes:

The network-side device sends the dataset (e.g., Ein & Eout) to the terminals through broadcast or group-specific signaling. Alternatively, only the output dataset (Eout) associated with a specific terminal may be sent. The dataset may be transmitted to the terminal through higher-layer signaling such as RRC signaling or converted into regular downlink data and broadcast to multiple terminals.

In some embodiments, training Type 1 includes: the network-side device triggers or deactivates semi-persistent or aperiodic reference signals through signaling to start or stop downlink channel data collection. In an embodiment, the network-side device may configure through signaling the terminal to collect a certain amount of data periodically and then stop data collection.

Training Types 1/2/3: the network-side device initiates data collection and notifies the terminal to report at least one of the BP dataset, estimated downlink channel information, feature vector corresponding to downlink channel information, Type II codebook-like feature vector, or terminal ID dataset to the network-side device through signaling. The network-side device then instructs the terminal to stop data collection through signaling. In an embodiment, the terminal may initiate a data collection request and actively report at least one of the FP, estimated downlink channel information, feature vector corresponding to downlink channel information, Type II codebook-like feature vector, or terminal ID dataset to the network-side device, and request the network-side device to send to the terminal the dataset or auxiliary information for training the CSI generation part model corresponding to the terminal.

The signaling sent by the network-side device includes at least one of RRC signaling, MAC-CE, or DCI signaling. In an embodiment, the network-side device may send an event trigger instruction to notify the terminal to start or stop data collection.

In some embodiments, data collection under the coexistence of multiple training types such as Training Type 1/2/3 includes:

First, the network-side device configures or the terminal reports the training type (Type 1, Type 2, or Type 3) for training the AI/ML model. The corresponding method for collecting data is then determined based on the training type.

In an embodiment, data collection by the network-side device (using Method 1).

Assume the base station (network-side device) has 16 transmit antenna ports. To train the CSI generation part model (i.e., CSI generation model) and the CSI recovery part model (i.e., CSI recovery model) at the base station, the base station needs to obtain the downlink channel information from the base station to each UE for training the CSI generation part model and the CSI recovery part model. First, a cell-specific downlink reference signal can be designed. Assume the reference signal uses traditional CSI-RS, i.e., the sequence and pattern design are consistent with that of traditional CSI-RS. Unlike traditional CSI-RS, which is configured separately for each UE, different UEs can be configured with the same or different numbers of CSI-RS ports and transmit power. The base station then collects the downlink channel state information of different UEs based on the cell-specific CSI-RS through the following steps:

Step 1: the base station broadcasts the cell-specific CSI-RS to all UEs in the cell.

Step 2: the UEs estimate the downlink channel information based on the received cell-specific CSI-RS. The UEs then approximate the feature vector corresponding to the downlink channel information using the Rel-16 Type II codebook structure

$$W = {W}_{1} \tilde{{W}_{2}} {W}_{f}^{H}$$

The codebook parameters (e.g., the number of spatial basis vectors and frequency-domain basis vectors) are configured by the base station.

Step 3: each UE reports the parameters of the codebook structure using the Rel-16 Type II codebook feedback method. The base station calculates the approximate feature vector corresponding to the downlink channel information using

$$W = {W}_{1} \tilde{{W}_{2}} {W}_{f}^{H} .$$

base on indication information of codebook parameters.

The base station can then train the CSI generation part model and the CSI recovery part model based on the approximate feature vector information of each UE obtained in Step 3.

In an embodiment, the base station may group UEs with the same area ID in a specific area and broadcast a group-specific reference signal (e.g., group CSI-RS) to the UEs in the group. Similarly, the above three steps can be used to train a CSI generation part model and a CSI recovery part model specific to the area, thereby improving the effectiveness of CSI compression.

In an embodiment, data collection by the network-side device (Method 2) includes:

For FDD systems, if the difference between uplink and downlink carrier frequencies is not greater than 1 GHz (e.g., less than 1 GHz) and both belong to the FRI frequency band, the angle and delay information of multipaths in the uplink and downlink channels exhibit reciprocity. Therefore, the network-side device can use this reciprocity to obtain downlink channel information with reduced feedback overhead. For example, as shown in FIG. 17, the base station (gNB) obtains the downlink channel information of each UE through the following three steps:

Step 1: Each UE sends an SRS to the base station. The base station estimates the uplink channel information based on the received SRS and calculates the angle and delay information of B transmission paths based on the uplink channel information. The angle and delay information of the transmission path can be represented by basis vectors in a spatial unitary matrix and a frequency-domain unitary matrix. If the angle of the b-th transmission path is represented by the spatial basis vector s_{b}, and the delay information of this transmission path is represented by the frequency basis vector f_{b}.

Step 2: the base station sends beamformed CSI-RS through B CSI-RS ports. The beam of each port can be represented as

$${f}_{b} ⊗ {s}_{b}^{*} .$$

Step 3: assume the UE is deployed with Nr receive ports. The UE calculates the effective channel information H_{eff}∈ [symbol] ^{N}^{ᵣ}^{×B} based on the B received beamformed CSI-RS ports and quantizes H_{eff} and then reports the quantized H_{eff} to the base station. Alternatively, the UE may select some ports and report the quantized effective channel information H′_{eff}∈ [symbol] ^{N}^{ᵣ}^{×B′} to the base station, where B′ is the number of selected ports. In an embodiment, the UE may quantize port combination coefficients or combination coefficients corresponding to some ports obtained by eigenvalue decomposition on

$${H}_{e f f}^{H} {H}_{e f f} or {( {H}_{eff}^{′} )}^{H} {H}_{eff}^{′}$$

and then report the quantized port combination coefficients or combination coefficients corresponding to some ports to the base station. In practice, due to other factors, the delay information of the uplink and downlink channels may have offsets or may not achieve ideal reciprocity. Therefore, the UE may also report multiple frequency-domain basis vectors to compensate for the offset in delay information.

The base station calculates the approximate downlink channel information as a training dataset for the AI/ML model, based on the port combination coefficients obtained in Step 3 and the CSI-RS port beam obtained from the uplink channel or the frequency-domain basis vectors reported by the UE. Alternatively, the base station calculates the vector information approximate with the feature vector corresponding to the down channel information as a training dataset for the AI/ML model.

The UE reports the port selection indication information, port combination coefficients quantization indication information or frequency-domain basis vector indication information to the base station through CSI carried on the PUSCH, in a way similar to the Rel-16 Type II or Rel-17 Type II port selection codebook.

In an embodiment, data collection by the terminal includes:

For NW-first training in the training Type 3, the network-side device first completes the training of the CSI generation part model and the CSI recovery part model based on the collected data. During the training of the CSI generation part model, the network-side device saves the input dataset Eᵢₙ and/or output dataset Eₒᵤₜ. When the terminal needs to train the CSI generation part model, the network-side device sends the input dataset Eᵢₙ and output dataset Eₒᵤₜ to the UE or only sends the output dataset Eₒᵤₜ associated with the CSI generation part model.

When multiple UEs in the cell have the capability to train the CSI generation part model, the base station may broadcast the datasets Eᵢₙ and Eₒᵤₜ to these UEs for model training. For cases where only the output dataset Eₒᵤₜ is transmitted, the base station can only send the output dataset Eₒᵤₜ to the UE associated with the output dataset Eₒᵤₜ. The base station may send the dataset to multiple UEs through broadcast RRC signaling or convert the dataset into regular downlink data and broadcast it to multiple UEs.

The embodiments of the present disclosure provide a reference signal enhancement and signaling process design method to implement data collection for training AI/ML models by the network-side device or terminal. The proposed design method can reduce downlink signaling overhead. Alternatively, the network-side device can collect downlink channel information datasets with reduced terminal feedback overhead.

In the above embodiments provided by the present disclosure, the methods are described from the perspectives of the network-side device and the terminal, respectively.

Please refer to FIG. 18, which is a schematic structural diagram of a communication apparatus 1 in an embodiment of the present disclosure. The communication apparatus 1 shown in FIG. 18 may include a transceiver module 11 and a processing module. The transceiver module may include a sending module and/or a receiving module, where the sending module is used to implement sending functionality, and the receiving module is used to implement receiving functionality. The transceiver module can implement sending and/or receiving functionality.

The communication apparatus 1 may be a terminal, an apparatus in a terminal, or an apparatus that can be used in conjunction with a terminal. Alternatively, the communication apparatus 1 may be a network-side device, an apparatus in a network-side device, or an apparatus that can be used in conjunction with a network-side device.

When the communication apparatus 1 is configured on the network-side device side:
the communication apparatus 1 includes a transceiver module 11.

The transceiver module 1 is configured to receive first data information sent by a terminal to perform a model processing of a CSI generation model and/or a CSI recovery model or calculate CSI based on the first data information.

In some embodiments, the first data information includes at least one of the following:
forward propagation (FP) data;
estimated downlink channel information;
a feature vector corresponding to downlink channel information;
input data during training of the CSI recovery model at the terminal;
output data during training of the CSI recovery model at the terminal;
codebook parameter information;
compressed estimated downlink channel information;
a compressed feature vector corresponding to downlink channel information;
compressed input data during training of the CSI recovery model at the terminal;
compressed output data during training of the CSI recovery model at the terminal;
compressed codebook vector information.

In some embodiments, the transceiver module 11 is further configured to send a reference signal to a terminal meeting specific conditions, where the reference signal is used to instruct the terminal meeting the specific conditions to collect the first data information based on the reference signal and send it to the network-side device.

The specific conditions include at least one of the following:
the terminal belonging to a specific cell;
the terminal belonging to a specific terminal group;
the terminal belonging to a specific area.

In some embodiments, the transceiver module 11 is further configured to send the reference signal to the terminal meeting the specific conditions via broadcast.

In some embodiments, the transceiver module 11 is further configured to receive indication information sent by the terminal, where the indication information is used to indicate at least one of the following:
the geographical location of the terminal;
the area identifier of the terminal;
the time-domain channel characteristics reported by the terminal; or
the time-domain correlation of the terminal.

In some embodiments, the communication apparatus 1 further includes a processing module 12.

The processing module 12 is configured to determine a terminal group, or an area, or a moving speed of the terminal based on the indication information.

In some embodiments, the transceiver module 11 is further configured to receive an SRS sent by the terminal. The processing module 12 is further configured to estimate uplink channel information based on the SRS and calculate a CSI-RS port beam for transmitting CSI-RS. The transceiver module 11 is further configured to send a beamformed CSI-RS to the terminal.

In some embodiments, the first data information further includes at least one of the following:
a port combination coefficient;
a frequency-domain basis vector;
port selection indication information.

In some embodiments, the processing module 12 is further configured to calculate estimated downlink channel information based on the CSI-RS port beam and at least one of the port combination coefficient, frequency-domain basis vector, or port selection indication information.

In some embodiments, when the network-side device trains the CSI recovery model based on the first data information, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

In some embodiments, the transceiver module 11 is further configured to send second data information to the terminal in response to determining that model processing of the CSI generation model or calculation of CSI needs to be performed at the terminal.

In some embodiments, the transceiver module 11 is further configured to send the second data information to the terminal via broadcast.

In some embodiments, the transceiver module 11 is further configured to send RRC signaling to the terminal, where the RRC signaling includes the second data information.

In some embodiments, the second data information includes at least one of the following:
backward propagation (BP) data;
the identifier of the terminal;
input data during training of the CSI generation model at the network-side device; or
output data during training of the CSI generation model at the network-side device.

In some embodiments, the second data information further includes second auxiliary information, where the second auxiliary information includes: preprocessing information of the CSI generation model or quantization method indication information output by the CSI generation model when the CSI generation model and the CSI recovery model are trained at the network-side device.

In some embodiments, the quantization method indication information includes indication information using a uniform scalar quantization method, indication information using a non-uniform scalar quantization method, or indication information using a vector quantization method, where a vector quantization codebook is indicated when the vector quantization method is used.

In some embodiments, the transceiver module 11 is further configured to send event indication information to the terminal, where the event indication information is used to instruct the terminal to collect the first data information when a specific event is met and/or stop collecting the first data information when the specific event is not met.

In some embodiments, the transceiver module 11 is further configured to receive first indication information sent by the terminal, where the first indication information is used to instruct the network-side device to perform a model processing of the CSI generation model and/or the CSI recovery model or calculate CSI.

In some embodiments, the transceiver module 11 is further configured to send second indication information to the terminal, where the second indication information is used to indicate that the network-side device needs to perform a model processing of the CSI generation model and/or the CSI recovery model or calculate CSI.

When the communication apparatus is configured on the terminal side:
the communication apparatus 1 includes: a transceiver module 11.

The transceiver module 11 is configured to send first data information to a network-side device, where the first data information is used for the network-side device to perform a model processing of a CSI generation model and/or a CSI recovery model or calculate CSI.

In some embodiments, the first data information includes at least one of the following:
FP data;
estimated downlink channel information;
a feature vector corresponding to downlink channel information;
input data during training of the CSI recovery model at the terminal;
output data during training of the CSI recovery model at the terminal;
codebook parameter information;
compressed FP data;
compressed estimated downlink channel information;
a compressed feature vector corresponding to downlink channel information;
compressed input data during training of the CSI recovery model at the terminal;
compressed output data during training of the CSI recovery model at the terminal; or
compressed codebook parameter information.

In some embodiments, the transceiver module 11 is further configured to receive, by the terminal meeting specific conditions, a reference signal sent by the network-side device, where the reference signal is used to instruct the terminal meeting the specific conditions to collect the first data information based on the reference signal and send the first data information to the network-side device.

The specific conditions include at least one of the following:
the terminal belonging to a specific cell;
the terminal belonging to a specific terminal group; or
the terminal belonging to a specific area.

In some embodiments, the transceiver module 11 is further configured to send indication information to the network-side device, where the indication information is used to indicate at least one of the following:
the geographical location of the terminal;
the area identifier of the terminal;
the time-domain channel characteristics reported by the terminal; or
the time-domain correlation of the terminal.

In some embodiments, the transceiver module 11 is further configured to send an SRS to the network-side device and receive a beamformed CSI-RS sent by the network-side device.

In some embodiments, the first data information further includes at least one of the following:
a port combination coefficient;
a frequency-domain basis vector; or
port selection indication information.

In some embodiments, the first data information further includes first auxiliary information, where the first auxiliary information includes: preprocessing information output by the CSI recovery model or quantization method indication information output by the CSI generation model and reported by the terminal when the CSI generation model and the CSI recovery model are trained at the terminal.

In some embodiments, the transceiver module 11 is further configured to receive second data information sent by the network-side device to perform model training of the CSI generation model or calculate the CSI based on the second data information.

In some embodiments, the transceiver module 11 is further configured to receive the second data information sent by the network-side device via broadcast.

In some embodiments, the transceiver module 11 is further configured to receive RRC signaling sent by the network-side device, where the RRC signaling includes the second data information.

In some embodiments, the second data information includes at least one of the following:
BP data;
the identifier of the terminal;
input data during training of the CSI generation model at the network-side device; or
output data during training of the CSI generation model at the network-side device.

In some embodiments, the second data information further includes second auxiliary information, where the second auxiliary information includes: preprocessing information of the CSI generation model or quantization method indication information output by the CSI generation model when the CSI generation model and the CSI recovery model are trained at the network-side device.

In some embodiments, the quantization method indication information includes indication information using a uniform scalar quantization method, indication information using a non-uniform scalar quantization method, or indication information using a vector quantization method, where a vector quantization codebook is indicated when the vector quantization method is used.

In some embodiments, the transceiver module 11 is further configured to receive event indication information sent by the network-side device, where the event indication information is used to instruct the terminal to collect the first data information when a specific event is met and/or stop collecting the first data information when the specific event is not met.

In some embodiments, the transceiver module 11 is further configured to send first indication information to the network-side device, where the first indication information is used to instruct the network-side device to perform a model processing of the CSI generation model and/or the CSI recovery model or calculate CSI.

In some embodiments, the transceiver module 11 is further configured to receive second indication information sent by the network-side device, where the second indication information is used to indicate that the network-side device needs to perform a model processing of the CSI generation model and/or the CSI recovery model or calculate CSI.

For the communication apparatus 1 in the above embodiments, the specific implementation of each module performing operations has been described in detail in the method embodiments and will not be repeated here.

The communication apparatus 1 provided in the above embodiments of the present disclosure achieves the same or similar beneficial effects as the method for collecting data provided in some of the above embodiments, which will not be repeated here.

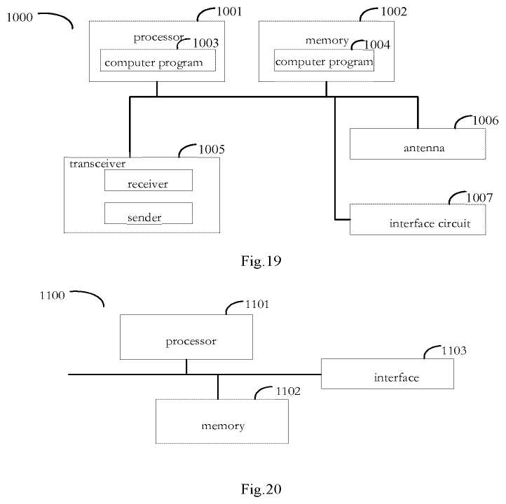

Please refer to FIG. 19, which is a schematic structural diagram of another communication apparatus 1000 in an embodiment of the present disclosure. The communication apparatus 1000 may be a terminal, a network-side device, a chip, a chip system, or a processor that supports the terminal in implementing the above methods, or a chip, a chip system, or a processor that supports the network-side device in implementing the above methods. The communication apparatus 1000 may be used to implement the methods described in the above method embodiments. For details, refer to the descriptions in the above method embodiments.

The communication apparatus 1000 may include one or more processors 1001. The processor 1001 may be a general-purpose processor or a dedicated processor, such as a baseband processor or a central processing unit (CPU). The baseband processor may be used to process communication protocols and communication data, and the CPU may be used to control the communication apparatus (such as a network-side device, a baseband chip, a terminal, a terminal chip, a DU, or a CU), execute computer programs, and process data of the computer programs.

In an embodiment, the communication apparatus 1000 may further include one or more memories 1002, on which a computer program 1004 may be stored. The processor 1001 executes the computer program 1004 to enable the communication apparatus 1000 to perform the methods described in the above method embodiments. In an embodiment, the memory 1002 may further store data. The communication apparatus 1000 and the memory 1002 may be separately configured or integrated together.

In an embodiment, the communication apparatus 1000 may further include a transceiver 1005 and an antenna 1006. The transceiver 1005 may be referred to as a transceiver unit, a transceiver machine, or a transceiver circuit, and is used to implement transceiver functions. The transceiver 1005 may include a receiver and a transmitter. The receiver may be referred to as a receiver machine or a receiver circuit and is used to implement receiving functions. The transmitter may be referred to as a transmitter machine or a transmitter circuit and is used to implement transmitting functions.

In an embodiment, the communication apparatus 1000 may further include one or more interface circuits 1007. The interface circuit 1007 is used to receive code instructions and transmit them to the processor 1001. The processor 1001 runs the code instructions to enable the communication apparatus 1000 to perform the methods described in the above method embodiments.

When the communication apparatus 1000 is a network-side device, the transceiver 1005 and the processor 1001 are used to perform the steps shown in FIGS. 3 to 9.

When the communication apparatus 1000 is a terminal, the transceiver 1005 and the processor 1001 are used to perform the steps shown in FIGS. 10 to 16.

In one implementation, the processor 1001 may include a transceiver for implementing receiving and transmitting functions. For example, the transceiver may be a transceiver circuit, an interface, or an interface circuit. The transceiver circuit, interface, or interface circuit used to implement receiving and transmitting functions may be separate or integrated. The transceiver circuit, interface, or interface circuit may be used to read/write code/data, or the transceiver circuit, interface, or interface circuit may be used to transmit or transfer signals.

In one implementation, the processor 1001 may store a computer program 1003. The computer program 1003 runs on the processor 1001 to enable the communication apparatus 1000 to perform the methods described in the above method embodiments. The computer program 1003 may be fixed in the processor 1001. In this case, the processor 1001 may be implemented by hardware.

In one implementation, the communication apparatus 1000 may include a circuit. The circuit may implement the sending, receiving, or communication functions in the foregoing method embodiments. The processor and transceiver described in the present disclosure may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and transceiver may also be manufactured using various IC process technologies, such as complementary metal-oxide-semiconductor (CMOS), N-type metal-oxide-semiconductor (NMOS), P-type metal-oxide-semiconductor (PMOS), bipolar junction transistor (BJT), bipolar CMOS (BiCMOS), silicon germanium (SiGe), gallium arsenide (GaAs), or the like.

The communication apparatus described in the foregoing embodiments may be a terminal or a network-side device, but the scope of the communication apparatus described in the present disclosure is not limited thereto, and the structure of the communication apparatus may not be limited by FIG. 19. The communication apparatus may be an independent device or may be a part of a larger device. For example, the communication apparatus may be: (1) an independent integrated circuit (IC), a chip, a chip system, or a subsystem; (2) a set of one or more ICs, optionally, the set of ICs may also include a storage component for storing data and computer programs; (3) an ASIC, such as a modem (Modem); (4) a module that can be embedded in other devices; (5) a receiver, a terminal, an intelligent terminal, a cellular phone, a wireless device, a handheld device, a mobile unit, an in-vehicle device, a network-side device, a cloud device, an artificial intelligence device, or the like; (6) others, etc.

For the case where the communication apparatus is a chip or a chip system, refer to FIG. 20, which is a schematic structural diagram of a chip in an embodiment of the present disclosure.

The chip 1100 includes a processor 1101 and an interface 1103. The number of processors 1101 may be one or more, and the number of interfaces 1103 may be multiple.

For the case where the chip is used to implement the functions of the terminal in the embodiments of the present disclosure:

The interface 1103 is configured to receive code instructions and transmit them to the processor.

The processor 1101 is configured to run the code instructions to perform the method for collecting data described in the foregoing embodiments.

For the case where the chip is used to implement the functions of the network-side device in the embodiments of the present disclosure:

The interface 1103 is configured to receive code instructions and transmit them to the processor.

The processor 1101 is configured to run the code instructions to perform the method for collecting data described in the foregoing embodiments.

In an embodiment, the chip 1100 may further include a memory 1102. The memory 1102 is configured to store necessary computer programs and data.

Those skilled in the art may further understand that the various illustrative logical blocks and steps listed in the embodiments of the present disclosure can be implemented through electronic hardware, computer software, or a combination of both. Whether such functionality is implemented as hardware or software depends on the specific application and design requirements of the overall system. Those skilled in the art may use various methods to implement the described functionality for each specific application, but such implementation should not be interpreted as exceeding the scope of protection of the embodiments of the present disclosure.

The embodiments of the present disclosure also provide a data collection system, which includes the communication device as a terminal and the communication device as a network-side device in the embodiment of FIG. 18, or the system includes the communication device as a terminal and the communication device as a network-side device in the embodiment of FIG. 19.

The present disclosure further provides a readable storage medium having instructions stored thereon, which, when executed by a computer, implement the functionality of any of the aforementioned method embodiments.

The present disclosure further provides a computer program product, when executed by a computer, implements the functionality of any of the aforementioned method embodiments.

In the above embodiments, the functionality may be implemented entirely or partially by software, hardware, firmware, or any combination thereof. When implemented by software, the functionality may be realized entirely or partially in the form of a computer program product. The computer program product includes one or more computer programs. When the computer program is loaded and executed on a computer, the processes or functions described in the embodiments of the present disclosure are generated entirely or partially. The computer may be a general-purpose computer, a specialized computer, a computer network, or other programmable devices. The computer program may be stored in a computer-readable storage medium or transmitted from one computer-readable storage medium to another. For example, the computer program may be transmitted from a website, computer, server, or data center to another website, computer, server, or data center via wired means (e.g., coaxial cable, optical fiber, digital subscriber line (DSL)) or wireless means (e.g., infrared, wireless, microwave, etc.). The computer-readable storage medium may be any available medium accessible by a computer or a data storage device such as a server or data center integrating one or more available media. The available medium may be a magnetic medium (e.g., floppy disk, hard disk, magnetic tape), an optical medium (e.g., high-density digital video disc (DVD)), or a semiconductor medium (e.g., solid-state disk (SSD)), etc.

Those skilled in the art may understand that the various numerical designations such as “first,” “second,” etc., in the present disclosure are merely for convenience of description and are not intended to limit the scope of the embodiments of the present disclosure, nor do they indicate any order of precedence.

In the present disclosure, “at least one” may also be described as “one or more,” and “multiple” may refer to two, three, four, or more, without limitation by the present disclosure. In the embodiments of the present disclosure, for a technical feature, terms such as “first,” “second,” “third,” “A,” “B,” “C,” and “D” are used to distinguish between the technical features within that category, and there is no sequential or hierarchical order among the technical features described by “first,” “second,” “third,” “A,” “B,” “C,” and “D.”

Depending on the context, the terms “if” and “when” as used herein may be interpreted as “at the time of” or “upon” or “in response to determining.”

The correspondence relationships shown in the tables of the present disclosure may be configured or predefined. The values of the information in the tables are merely examples and may be configured as other values, which are not limited by the present disclosure. When configuring the correspondence relationships between information and parameters, it is not necessary to include all the relationships illustrated in the tables. For example, some rows showing correspondence relationships in the tables of the present disclosure may not be configured. Alternatively, appropriate adjustments may be made to the tables, such as splitting or merging, etc. The parameter names indicated in the headers of the tables may also be replaced with other names understandable by communication devices, and the values or representations of the parameters may also be other values or representations understandable by communication devices. The tables may also be implemented using other data structures, such as arrays, queues, containers, stacks, linear lists, pointers, linked lists, trees, graphs, structures, classes, heaps, hash tables, etc.

“Predefined” in the present disclosure may be understood as defined, predefined, stored, pre-stored, pre-negotiated, pre-configured, solidified, or pre-burned.

Those skilled in the art may realize that the units and algorithm steps of the examples described in the embodiments disclosed herein can be implemented by electronic hardware, computer software, or a combination of both. Whether these functions are performed by hardware or software depends on the specific application and design constraints of the technical solution. Professionals may use different methods to implement the described functionality for each specific application, but such implementation should not be considered beyond the scope of the present disclosure.

Those skilled in the art may clearly understand that, for the convenience and brevity of description, the specific working processes of the systems, devices, and units described above may refer to the corresponding processes in the aforementioned method embodiments and are not repeated here.

The above descriptions are merely specific implementations of the present disclosure, but the scope of protection of the present disclosure is not limited thereto. Any person skilled in the art can easily think of changes or substitutions within the technical scope disclosed in the present disclosure, which should be covered by the scope of protection of the present disclosure. Therefore, the scope of the present disclosure shall be subject to the scope of the claims.

1. A method for collecting data, performed by a network-side device, comprising:
receiving first data information sent by a terminal to perform a model processing of a channel state information (CSI) generation model and/or a CSI recovery model or calculate CSI based on the first data information.

2. The method according to claim 1, wherein the first data information comprises at least one of:
forward propagation (FP) data;
estimated downlink channel information;
a feature vector corresponding to downlink channel information;
input data during a training of the CSI recovery model at the terminal;
output data during a training of the CSI recovery model at the terminal;
codebook parameter information;
compressed estimated downlink channel information;
a compressed feature vector corresponding to downlink channel information;
compressed input data during a training of the CSI recovery model at the terminal;
compressed output data during a training of the CSI recovery model at the terminal; or
compressed codebook vector information.

3. The method according to claim 1, further comprising:
sending a reference signal to the terminal meeting a specific condition, wherein the reference signal is used to instruct the terminal meeting the specific condition to collect the first data information based on the reference signal and send the first data information to the network-side device,
wherein the specific condition comprises at least one of:
the terminal belonging to a specific cell;
the terminal belonging to a specific terminal group; or
the terminal belonging to a specific area.

4. The method according to claim 3, wherein sending the reference signal to the terminal meeting the specific condition comprises:
sending the reference signal to the terminal meeting the specific condition via broadcast; or
the method further comprises:
receiving indication information sent by the terminal, wherein the indication information is used to indicate at least one of:
a geographical location of the terminal;
an area identifier of the terminal;
a time-domain channel characteristic reported by the terminal; or
a time-domain correlation of the terminal,
wherein the method further comprises:
determining, based on the indication information, a terminal group, or an area, or a moving speed of the terminal.

5-6. (canceled)

7. The method according to claim 1, further comprising:
receiving a sounding reference signal (SRS) sent by the terminal;
estimating uplink channel information based on the SRS, and calculating a CSI reference signal (CSI-RS) port beam for transmitting CSI-RS; and
sending a beamformed CSI-RS to the terminal,
wherein the first data information further comprises at least one of:
a port combination coefficient;
a frequency-domain basis vector; or
port selection indication information.

8. (canceled)

9. The method according to claim 7, further comprising:
calculating the estimated downlink channel information based on the CSI-RS port beam and at least one of the port combination coefficient, the frequency-domain basis vector or the port selection indication information.

10. The method according to claim 2, wherein in a case where the network-side device trains the CSI recovery model based on the first data information, the first data information further comprises first auxiliary information, and the first auxiliary information comprises: preprocessing information output by the CSI recovery model or quantization method indication information output by the CSI generation model and reported by the terminal in a case where the CSI generation model and the CSI recovery model are trained at the terminal.

11. The method according to claim 1, further comprising:
sending second data information to the terminal in response to determining that the model processing of the CSI generation model is to be performed or the CSI is to be calculated at the terminal,
wherein the second data information comprises at least one of:
backward propagation (BP) data;
an identifier of the terminal;
input data during a training of the CSI generation model at the network-side device; or
output data during a training of the CSI generation model at the network-side device.

12-14. (canceled)

15. The method according to claim 11, wherein the second data information further comprises second auxiliary information, and the second auxiliary information comprises: preprocessing information of the CSI generation model or quantization method indication information output by the CSI generation model in a case where the CSI generation model and the CSI recovery model are trained at the network-side device, and
wherein the quantization method indication information comprises indication information using a uniform scalar quantization method, or indication information using a non-uniform scalar quantization method, or indication information using a vector quantization method, wherein a vector quantization codebook is indicated in a case where the vector quantization method is used.

16. (canceled)

17. The method according to claim 1, further comprising:
sending event indication information to the terminal, wherein the event indication information is used to instruct the terminal to collect the first data information in a case where a specific event is met and/or stop collecting the first data information in a case where the specific event is not met; or
the method further comprises:
receiving first indication information sent by the terminal, wherein the first indication information is used to instruct the network-side device to perform the model processing of the CSI generation model and/or the CSI recovery model or calculate CSI; or
the method further comprises:
sending second indication information to the terminal, wherein the second indication information is used to indicate that the network-side device performs the model processing of the CSI generation model and/or the CSI recovery model or calculate CSI.

18-19. (canceled)

20. A method for collecting data, performed by a terminal, comprising:
sending first data information to a network-side device, wherein the first data information is used for the network-side device to perform a model processing of a CSI generation model and/or a CSI recovery model or calculate CSI.

21. The method according to claim 20, wherein the first data information comprises at least one of:
FP data;
estimated downlink channel information;
a feature vector corresponding to downlink channel information;
input data during a training of the CSI recovery model at the terminal;
output data during a training of the CSI recovery model at the terminal;
codebook parameter information;
compressed FP data;
compressed estimated downlink channel information;
a compressed feature vector corresponding to downlink channel information;
compressed input data during a training of the CSI recovery model at the terminal;
compressed output data during a training of the CSI recovery model at the terminal; or
compressed codebook parameter information.

22. The method according to claim 20, further comprising:
receiving, by the terminal meeting a specific condition, a reference signal sent by the network-side device, wherein the reference signal is used to instruct the terminal meeting the specific condition to collect the first data information based on the reference signal and send the first data information to the network-side device,
wherein the specific condition comprises at least one of:
the terminal belonging to a specific cell;
the terminal belonging to a specific terminal group; or
the terminal belonging to a specific area,
wherein the method further comprises:
sending indication information to the network-side device, wherein the indication information is used to indicate at least one of:
a geographical location of the terminal;
an area identifier of the terminal;
a time-domain channel characteristic reported by the terminal; or
a time-domain correlation of the terminal.

23. (canceled)

24. The method according to claim 20, further comprising:
sending an SRS to the network-side device; and
receiving a beamformed CSI-RS sent by the network-side device,
wherein the first data information further comprises at least one of:
a port combination coefficient;
a frequency-domain basis vector; or
port selection indication information.

25. (canceled)

26. The method according to claim 20, wherein the first data information further comprises first auxiliary information, and the first auxiliary information comprises: preprocessing information output by the CSI recovery model or quantization method indication information output by the CSI generation model and reported by the terminal in a case where the CSI generation model and the CSI recovery model are trained at the terminal.

27. The method according to claim 20, further comprising:
receiving second data information sent by the network-side device to perform a model training of the CSI generation model or calculate the CSI based on the second data information,
wherein the second data information comprises at least one of:
BP data;
an identifier of the terminal;
input data during a training of the CSI generation model at the network-side device; or
output data during a training of the CSI generation model at the network-side device.

28-30. (canceled)

31. The method according to claim 27, wherein the second data information further comprises second auxiliary information, and the second auxiliary information comprises: preprocessing information of the CSI generation model or quantization method indication information output by the CSI generation model in a case where the CSI generation model and the CSI recovery model are trained at the network-side device, and
wherein the quantization method indication information comprises indication information using a uniform scalar quantization method, or indication information using a non-uniform scalar quantization method, or indication information using a vector quantization method, wherein a vector quantization codebook is indicated in a case where the vector quantization method is used.

32. (canceled)

33. The method according to claim 20, further comprising:
receiving event indication information sent by the network-side device, wherein the event indication information is used to instruct the terminal to collect the first data information in a case where a specific event is met and/or stop collecting the first data information in a case where the specific event is not met; or
the method further comprises:
sending first indication information to the network-side device, wherein the first indication information is used to instruct the network-side device to perform the model processing of the CSI generation model and/or the CSI recovery model or calculate CSI; or
the method further comprises:
receiving second indication information sent by the network-side device, wherein the second indication information is used to indicate that the network-side device performs the model processing of the CSI generation model and/or the CSI recovery model or calculate CSI.

34-37. (canceled)

38. A communication apparatus, comprising a processor and a memory, wherein the memory stores a computer program, and the processor is configured to execute the computer program stored in the memory to cause the apparatus to perform the method according to claim 1.

39-40. (canceled)

41. A communication apparatus, comprising a processor and a memory, wherein the memory stores a computer program, and the processor is configured to execute the computer program stored in the memory to cause the apparatus to perform:
sending first data information to a network-side device, wherein the first data information is used for the network-side device to perform a model processing of a CSI generation model and/or a CSI recovery model or calculate CSI.
